(19) United States
(12) Patent Application Publication
(10) Pub. No.: US 2025/0008346 A1
(43) Pub. Date: Jan. 2, 2025

(54) METHODS AND DEVICES FOR MULTI-CELL RADIO RESOURCE MANAGEMENT ALGORITHMS

(71) Applicant: Intel Corporation, Santa Clara, CA (US)

(72) Inventors: Vaibhav SINGH, New Delhi (IN); Christian MACIOCCO, Portland, OR (US)

(21) Appl. No.: 18/342,807

(22) Filed: Jun. 28, 2023

(51) Int. Cl. H04W 24/02; G06N 20/00; H04W 72/04

(52) U.S. Cl. CPC H04W 24/02; G06N 20/00; H04W 72/04

(57) ABSTRACT

A device may include a memory configured to store an artificial intelligence or machine learning model (AI/ML) configured to provide an output used in radio resource management of a plurality of cells; and a processor configured to: obtain cell-specific parameters of the plurality of cells of a mobile communication network; select a subset of the plurality of cells based on obtained cell-specific parameters; and cause the AI/ML to be trained with radio access network (RAN)-related data of the subset of the plurality of cells.

### TECHNICAL FIELD

This disclosure generally relates to methods and devices for training artificial intelligence or machine learning models (AI/ML) for radio resource management and using such an AI/ML.

### BACKGROUND

In mobile radio communication networks, in accordance with many mobile radio communication technologies, such as Fourth Generation (LTE) and Fifth Generation (5G) New Radio (NR) and upcoming next generation radios, there are various techniques that are applied to manage radio resources. Such techniques may include controlling parameters associated with scheduling transmission of radio communication signals, transmit power, allocation of mobile communication devices within radio resources, beamforming, data rates for communications, handover functions, modulation and coding schemes, etc.

Radio resource managing entities of a mobile communication network may manage radio resources within the mobile communication network using radio resource management models employing various algorithms, such as artificial intelligence or machine learning models, to obtain and select parameters associated with the management of the radio resources. Due to varying conditions within the mobile communication network, a radio resource management model may be updated from time to time in order to fit the radio resource management model to the conditions of the mobile communication network.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary radio communication network;

FIG. 2 shows an exemplary internal configuration of a communication device;

FIG. 3 shows an exemplary illustration of cells of a mobile communication network;

FIG. 4 shows an example of a device according to various examples in this disclosure;

FIG. 5 shows an exemplary illustration of cell data;

FIG. 6 shows an exemplary illustration of RAN data;

FIG. 7 shows an example of a processor and a memory of a device according to various aspects provided in this disclosure;

FIG. 8 shows an exemplary illustration of training an AI/ML in accordance with various aspects provided herein;

FIG. 9 shows an exemplary illustration of communication paths between network access nodes and a device in accordance with various aspects provided herein;

FIG. 10 shows an exemplary illustration of selecting exemplary cells from a plurality of cells;

FIG. 11 shows an exemplary procedure including selecting cells from a plurality of cells;

FIG. 12 shows an exemplary representation of a reinforcement learning (RL) model based AI/ML;

FIG. 13 shows an exemplary illustration of various entities of a mobile communication network;

FIG. 14 shows an exemplary radio access network architecture in which the radio access network is disaggregated into multiple units;

FIG. 15 shows an example of an AI/ML;

FIG. 16 shows an example of a method; and

FIG. 17 shows an example of a method.

### DESCRIPTION

The following detailed description refers to the accompanying drawings that show, by way of illustration, exemplary details, and aspects in which aspects of the present disclosure may be practiced.

With exposure to terabytes (TBs) of data from the multiple radio access network (RAN) cells, different AI/ML-based Radio Resource Management (RRM) algorithms may be designed to learn from the network (e.g. RAN) load patterns, user patterns, network data traffic patterns, wireless environment patterns, and/or device mobility patterns to optimize the operation of one or multiple RANs. For example, RRM models associated with load balancing, CQI (Channel Quality Indicator) period optimization, connectivity optimization, and optimization of RAN resources such as MIMO usage, sub-band (frequency) usage, energy saving, etc. can be further optimized to support the workloads after learning past behaviors supported by the RAN and estimations/predictions/classifications, etc. accordingly with a level of uncertainty, sometimes in a near future. Such learning and predictions may be employed by training AI/MLs.

In some aspects, an AI/ML based (or AI/ML assisted) RRM algorithm may be used for managing operations of multiple networks and respective access nodes associated with (e.g. serving to) multiple cells of a cellular network. For this purpose, an AI/ML may be deployed in a network architecture of multiple cells at an entity that may communicate with multiple network access nodes in order to exchange information, such as to receive data to be used as input to the AI/ML and to provide information for the management of radio resources. For example, this entity may receive cell-specific parameters and RAN-related data from multiple access nodes associated with multiple cells. The AI/ML may provide an output (which may be referred to as an RRM output) including information for managing radio resources of one, some, or all of the multiple cells based on input data including received cell-specific parameters and/or RAN-related data. The entity may then send information representing, or associated with, the output of the AI/ML to the corresponding cell or cells. For example, with the development of Open RAN (O-RAN) standards, different functionalities of the RAN can be optimized by pushing the logic to an entity operating a RAN Intelligent Controller (RIC). The RIC can be distributed and handle multiple cells, to make more intelligent and data driven decisions.

There are certain key common and possibly central AI/ML that can serve with different RRM algorithms, for example, load prediction, spectral efficiency prediction, traffic prediction, etc., which may help optimize RAN resources to meet workload requirements. Such an AI/ML may have complexity at various levels and may require updates once deployed on the field. Once radio resources associated with multiple network access nodes are optimized, such an entity implementing the AI/ML may also inform other entities in the network about various performance metrics of the RAN. Accordingly, certain entities in the network may take appropriate actions, some of which may be based on the performance capabilities of entities in data communication within the network (e.g. source entity (i.e. provider) of the data, sink entity (i.e. receiver) of the data).

Employment of such AI/ML-based RRM algorithms may be considered critical to provide a desired network performance in various mobile radio communication technologies, such as 5G, 6G, and beyond. Training of the AI/MLs used for this purpose may involve a high amount of data transfer to obtain data from network access nodes (e.g., data transfer via E2/A1 interface in an O-RAN architecture) and computing and storage capacity of such data received from the transfer.

One option to train one or more AI/MLs used in AI/ML-based RRM algorithms include aggregating RAN-related data of all cells and using the aggregated data to train the one or more AI/MLs. For example, in a group of 100 cells, RAN-related data of the 100 cells are aggregated and used for training of the one or more AI/MLs, which may require a high amount of computation, network transmissions, memory and storage capacity and energy consumption. Another option to implement this is to use separate AI/MLs for each cell of the plurality of cells and train each AI/ML using RAN-related data of that cell used for the AI/ML respectively. This may also result in requiring a high amount of computation, network transmissions, energy consumption, and additionally high storage due to AI/ML per cell architecture. Furthermore, such options do not take into account operator preferences, especially in terms of computation overhead, power consumption, QoS maintenance, which such operator preferences may be dynamic. The set of cells are defined manually and they may not be changed in view of dynamic cell environments.

It may be desirable to reduce the amount of data transfer and associated data transmission, storage and computing for training these modules in a particular manner that would still keep desired performance metrics of these AI/MLs (e.g., accuracy, precision, error rate, cumulative reward, etc.) at a desired level. Reducing the amount of data transfer and limiting the associated computing may lead to low power consumption and ecological and sustainable footprints of deployments, thus helping to meet stringent environmental regulations as introduced into practice.

Aspects provided in this disclosure may relate to training of an AI/ML, in which the AI/ML is used by an entity of a communication network. The entity may be implemented by a device, such as a controller device, connectable to the communication network via a communication interface. In some aspects, the device may implement the AI/ML. In some aspects, the device may be connectable to a further device that implements the AI/ML. The device may include a processor and a memory to provide various aspects provided herein. The device may further include at least one communication interface to perform communications provided herein to exchange data with one or more further entities. In particular, the device may, via the communication interface, receive cell-specific parameters of a plurality of cells of a mobile communication network. Optionally, the communication interface may further receive RAN-related data of the plurality of cells or one or more cells of the plurality of cells. Optionally, the communication interface may further receive information from other entities in the mobile communication network, such as operator information including information provided by operators (e.g. an operator entity or an application). The device may, via the processor, process received data and cause the AI/ML to be trained according to the processed data. The device may further, via the processor, control the communication interface and/or the memory to implement various aspects provided herein. In some aspects, the device may implement a method (i.e. a computer-implemented method) to provide aspects disclosed herein.

Some of the aspects provided herein may include a determination, e.g. by a processor, of one or more cells from a plurality of cells. The AI/ML may provide one or more RRM outputs for the plurality of cells. In some aspects, the device may cause the AI/ML to be trained based on data (e.g. RAN-related data) received only from the one or more cells. Assuming first cells including the determined one or more cells of the plurality of cells and second cells including one or more remaining cells (or all remaining cells) of the plurality of cells, the device may cause the AI/ML to be trained based on data received from only first cells at least for a period of time (e.g. predefined or predetermined period of time), yet the AI/ML may still provide RRM outputs for the plurality of cells including the second cells. In other words, the AI/ML may be trained with only data received from the first cells (at least for a period of time) to reduce data transfer within the mobile communication network. The device may cause further entities that provide data received from the second cells (e.g. network access nodes of the second cells, and/or an intermediary entity in the mobile communication network, etc.) to cease providing such data, which is used to train the AI/ML.

Aspects provided in this disclosure may relate to using a trained AI/ML that has been trained as defined herein, in which the AI/ML is used by an entity of a communication network. The entity may be implemented by a device. The device may include a processor and a memory to provide various aspects provided herein. The device may further include at least one communication interface to perform communications provided herein to exchange data with one or more further entities. In particular, the device may, via the communication interface, receive RAN-related data of the plurality of cells or one or more cells of the plurality of cells. Optionally, the communication interface may further receive cell-specific parameters of a plurality of cells of a mobile communication network. Optionally, the communication interface may further receive information from other entities in the mobile communication network, such as operator information including information provided by operators (e.g. an operator entity or an application). The device may, via the processor, process received data and use the trained AI/ML. The device may further, via the processor, control the communication interface and/or the memory to implement various aspects provided herein. In some aspects, the device may implement a method (i.e. a computer-implemented method) to provide aspects disclosed herein.

These aspects (which may be implemented by e.g. a process, a method, a device configured to perform these aspects, or a logic) may, in particular, include dynamic identification (i.e. determination) of subset cells from the plurality of cells. The dynamic identification may be based on cell-specific parameters of each cell of the plurality of cells. The aspects may further include aggregating RAN-related data of the subset cells. The aspects may further include training the AI/ML used to provide RRM outputs for managing the radio resources of the plurality of cells with the aggregated RAN-related data of the subset of cells. The aspects may further include obtaining a goal of maximizing a performance metric and reducing computation or data aggregation overhead associated with the training.

In accordance with various aspects provided herein, training an AI/ML using RAN-related data may include the identification of an appropriate set of cells for data aggregation and setting training parameters based on operator preferences. Accordingly, the computational complexity of selecting the appropriate cells from a plurality of cells may be reduced exponentially in comparison with previous implementations. Some aspects provided herein training may further optimize Quality of Service (QOS) while minimizing data aggregation, computation, energy usage.

It is to be noted that the terms “AI model” and “machine learning model” are often used interchangeably in the literature, but there may also be some subtle differences between the two. An AI (Artificial Intelligence) model refers to a computational system that aims to perform tasks that would typically require human intelligence, such as problem-solving, pattern recognition, classification, and perception. AI models can be developed using various techniques, which may or may not include machine learning. AI models may include rule-based and rely on pre-defined logic, while they may also include the use of machine learning algorithms to adapt and improve over time. A machine learning model is considered a particular type of AI model that may learn from data. Machine learning models can be supervised (learning from labeled data), unsupervised (learning from unlabeled data), or reinforcement learning (learning from interactions with an environment). AI models that do not use machine learning techniques may typically include rule-based systems or systems that rely on pre-defined logic and knowledge representation. These models are designed and built by human experts who encode the rules and knowledge directly into the system. In this sense, they are not “trained” like machine learning models, which learn from data. However, rule-based AI models may also be updated and improved by refining the rules or adding new ones, which may require human intervention or may be provided via a particular training module that may change parameters associated with the defined rules. These updates can be considered a form of “training”. The term used in this disclosure, namely AI/ML, encompasses in particular machine learning models, but it may also include AIs that do not involve a machine learning model particularly, but which may be trained. The term “model” used herein may be understood as any kind of algorithm, which provides output data based on input data provided to the model (e.g., any kind of algorithm generating or calculating output data based on input data).

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18(3rd Generation Partnership Project Release 18), 3GPP 5G, 3GPP LTE Extra, LTE-Advanced Pro. LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mm Wave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHZ, 3.4-3.6 GHZ, 3.6-3.8 GHZ and further frequencies and SAS=Spectrum Access System in 3.55-3.7 GHZ and further frequencies), and may use various spectrum bands including, but not limited to, IMT (International Mobile Telecommunications) spectrum (including 450-470 MHZ, 790-960 MHZ, 1710-2025 MHZ, 2110-2200 MHZ, 2300-2400 MHZ, 2500-2690 MHZ, 698-790 MHZ, 610-790 MHZ, 3400-3600 MHZ, etc., where some bands may be limited to specific region(s) and/or countries), IMT-advanced spectrum, IMT-2020 spectrum (expected to include 3600-3800 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHZ, 42-42.5 GHZ, 57-64 GHZ, 64-71 GHZ, 71-76 GHZ, 81-86 GHz and 92-94 GHz, etc.), the ITS (Intelligent Transport Systems) band of 5.9 GHZ (typically 5.85-5.925 GHZ) and 63-64 GHZ, bands currently allocated to WiGig such as WiGig Band 1 (57.24-59.40 GHZ), WiGig Band 2 (59.40-61.56 GHz) and WiGig Band 3 (61.56-63.72 GHZ) and WiGig Band 4 (63.72-65.88 GHZ), the 70.2 GHZ-71 GHz band, any band between 65.88 GHZ and 71 GHZ, bands currently allocated to automotive radar applications such as 76-81 GHZ, and future bands including 94-300 GHZ and above. Furthermore, the apparatuses and methods described herein can also employ radio communication technologies on a secondary basis on bands such as the TV White Space bands (typically below 790 MHZ) where e.g. the 400 MHZ and 700 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or OFDM flavors (CP-OFDM, SC-FDMA, SC-OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

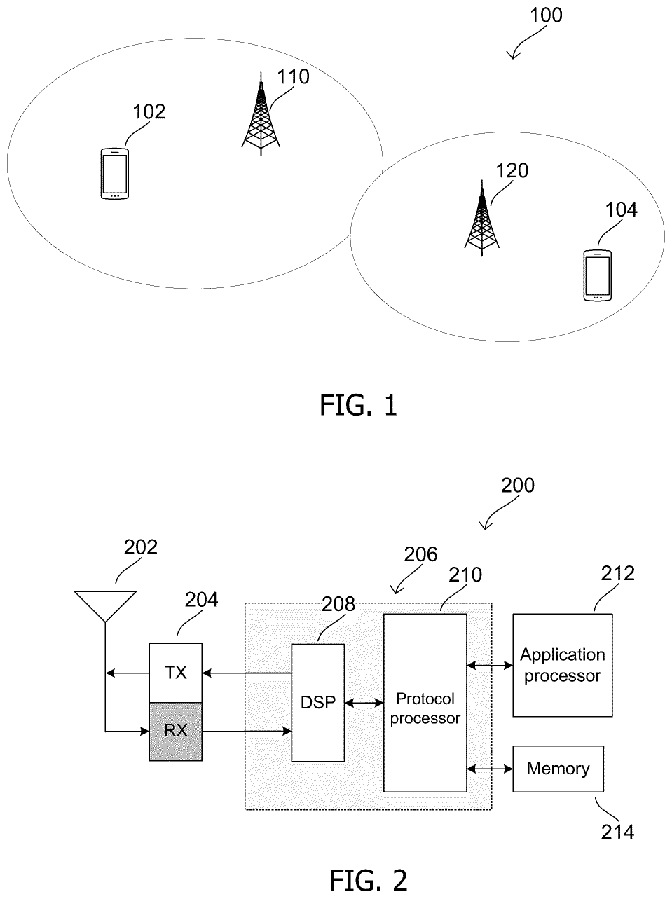

FIGS. 1 and 2 depict a general network and device architecture for wireless communications, including in particular aspects of a mobile communication network. In particular, FIG. 1 shows exemplary radio communication network 100 according to some aspects, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., LTE, UMTS, GSM, other 3rd Generation Partnership Project (3GPP) networks, WLAN/WiFi, Bluetooth, 5G NR, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., cNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or WiFi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, WiFi, mm Wave, etc., any of which may be applicable to radio communication network 100.

FIG. 2 shows an exemplary internal configuration of a communication device according to various aspects provided in this disclosure. The communication device may include a terminal device 102, and it will be referred to as communication device 200, but the communication device may also include various aspects of network access nodes 110, 120 as well. In some examples, the communication device 200 may be a further entity within the radio communication network 100, which may communicate with multiple network access nodes 110, 120. The communication device 200 may include antenna system 202, radio frequency (RF) transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness, the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAS), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

In some examples, communication device 200 may include a communication circuit. Communication device 200 may transmit and receive communication signals with the communication circuit. The communication circuit may be couplable to specified communication interfaces (e.g. E2, A1, O1, etc.). In some aspects, such communication interfaces may be implemented by wireless or wired connections (e.g. backhaul, etc.). In particular, the communication circuit may transmit and receive communication signals to/from network access nodes 110, 120, or an intermediate entity within the radio communication network 100 that may communicate with network access nodes 110, 120. The communication circuit may include RF transceiver 204, and in such an example, the RF transceiver 204 may be configured to transmit and receive communication signals via the respective communication interface.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions, where the one or more processors of digital signal processor 208 may offload certain processing tasks to these dedicated hardware circuits, which are known as hardware accelerators.

Exemplary hardware accelerators can include Fast Fourier Transform (FFT) circuits and encoder/decoder circuits. In some aspects, the processor and hardware accelerator components of digital signal processor 208 may be realized as a coupled integrated circuit. In accordance with various aspects provided herein, the digital signal processor 208 may implement the AI/ML and also AI/ML-based RRM algorithm operations some of which are described herein, and exemplarily via one or more dedicated hardware circuits (e.g., ASICs, FPGAs, and other hardware). In particular, the communication device 200 may include a plurality of such digital signal processors (e.g. digital signal processor 208) that are configured to implement multiple RRM algorithms. In an O-RAN environment, digital signal processors may perform processing, in particular for xApps or implement xApps.

Communication device 200 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

Application processor 212 may be configured to implement various operations provided herein, in particular with respect to the implementation of one or more AI/MLs that are used for RRM of multiple cells associated with multiple network access nodes (e.g. network access node 110, 120) serving to multiple terminal devices (e.g. terminal devices 102, 104). In some examples, application processor 212 may control an external processor that is configured to implement the one or more AI/MLs. In some aspects, the external processor may be particularly suitable for implementing AI/MLs, such as GPUs, neuromorphic chips or circuits, parallel processors, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, communication device 200 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

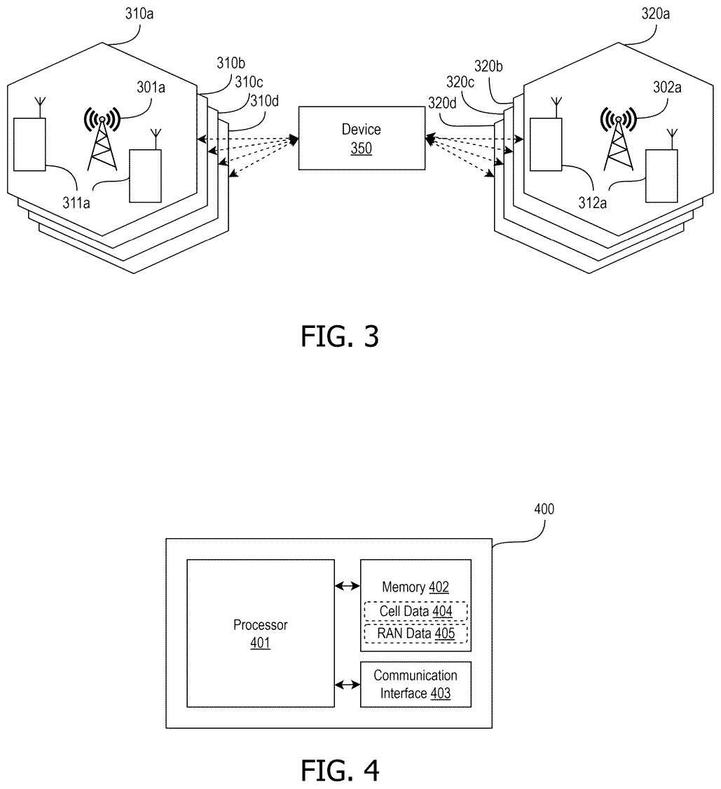

FIG. 3 shows an exemplary illustration of cells of a mobile communication network. Radio resource management models may provide their outputs on a cell-basis or on a multiple-cell basis, a cell being a particular geographical region covered by a network access node. The size of a cell may depend on the mobile radio communication technology used by the network access node associated with the cell. For example, within the context of a wireless local area network (WLAN), a cell may have a radius of up to 100 meters, while within the context of cellular communication a cell may have a radius of up to 50 kilometers.

The mobile communication network may include multiple cells 310a-d, 320a-d, each cell being associated a network access node (e.g. network access nodes 110, 120) configured to provide a radio access service to multiple terminal devices (e.g. terminal devices 102, 104). Aspects associated with the radio access service provided by the respective network access node may be represented in relation with the respective cell. In other words, the aspects provided in this disclosure with respect to a cell may also be represented as aspects with respect to the network access node and/or the radio access service provided by the network access node, which the network access node is the entity in the mobile communication network providing network access service for the cell. It is to be noted that the mobile communication network may include many cells associated with many network access nodes. For brevity, the aspects with respect to the cells in the mobile communication network in accordance with FIG. 3 are to be provided from the perspective of a first cell 310a and a second cell 320a, which are representative of each cell within the mobile communication network, or which are representative of each cell pair (i.e. any two cells) within the mobile communication network depending on the disclosed aspect.

A first cell 310a is depicted as it includes a first network access node 301a, such as a base station, and a second cell 320a is depicted as it includes a second network access node 302a. The network access nodes 301a, 302a may perform operations associated with the radio access network in order to provide radio coverage over the geographic areas that may be represented by the cells 310a, 320a respectively. First group of terminal devices 311a within the first cell 301a may access the mobile communication network over the first network access node 301a, and second group of terminal devices 312a within the second cell 302a may access the mobile communication network over the second network access node 302a. In some aspects, a terminal device may access the mobile communication network over multiple access nodes (e.g. the first network access node 301a and the second network access node 302a; not depicted).

A network access node, such as a base station, may provide network access services to terminal devices within a cell. With the recent employment of distributed radio access networks, one or more remote radio units may be deployed for a cell to communicate with terminal devices within the cell using radio communication signals. Accordingly, in this illustration, the depicted network access nodes 301a, 302a may include remote radio head units. Such remote radio units may be connected to further controller entities to communicate via wired (e.g. fronthaul) and/or wireless communications, and the controller entities (such as a controller unit, a central unit, a distributed unit) may manage radio resources associated with the one or more radio units within the cell.

The mobile communication network may include a device 350. Principally, the device 350 may provide an RRM service for the cells 310a-d, 320a-d. The device 350 may accordingly be configured to obtain cell-specific parameters and/or RAN-related parameters of the cells 310a-d, 320a-d. In some examples, the device 350 may directly communicate with the network access nodes of the cells 310a-d, 320a-d. In some examples, the device 350 may communicate with one or more intermediate entities of the mobile communication network, which the one or more intermediate entities may provide cell-specific parameters and/or RAN-related parameters of the cells 310a-d, 320a-d. The one or more intermediate entities may directly communicate with the network access nodes of the cells 310a-d, 320a-d. Alternatively, the one or more intermediate entities may communicate one or more further intermediate entities of the mobile communication network, which the one or more further intermediate entities may directly communicate with the network access nodes of the cells 310a-d, 320a-d.

In various examples, the device 350 may perform various functions to manage radio resources associated with the one or more radio units within the cell. Accordingly, the device 350 may implement at least one AI/ML used to provide the RRM service (e.g. an RRM output). The device may implement a radio resource management model, such as a trained artificial intelligence machine learning (AI/ML) model that is trained and configured to output at least one RRM output for at least one cell of the cells 310a-d, 320a-d. Based on the provided RRM output, at least one respective network access node associated with the at least one respective cell may manage the radio resources (e.g. schedule radio transmissions, allocate resources, handover a terminal device to another network access node, etc.).

In accordance with various aspects provided herein, in a distributed RAN architecture (e.g. Open RAN), the device 350 may be a device that is configured to operate as a near real-time RAN intelligent controller (a near RT RIC) may implement the trained AI/ML. An xApp, an application stored in the memory of the near-RT RIC may include the trained AI/ML. In such an example, the device 350 may communicate with Distributed Units (DUs) and Centralized Units (CUs) of the mobile communication network to receive cell-specific parameters, RAN-related data, and further data and provide RRM outputs via E2 interfaces. Furthermore, the device 350 may communicate with a Service Management and Orchestration entity (SMO) to receive operator information. The network access nodes may be considered as the combination of a DU, a CU, and a radio unit (RU).

Alternatively, or additionally, the device 350 may be a device that is configured to operate as a non-real-time RAN intelligent controller (a non-RT RIC) may implement the trained AI/ML. An xApp stored in the memory of the non-RT RIC (i.e. device) may include the trained AI/ML. In such an example, the device 350 may communicate with DUs and CUs of the mobile communication network to receive cell-specific parameters, RAN-related data, and further data and provide RRM outputs via E2 interfaces, and additionally and/or alternatively the device 350 may further communicate with a near-RT RIC via A1 interface to receive cell-specific parameters, RAN-related data, and further data and provide RRM outputs via E2 interfaces. The operator information may be stored in the device.

Conditions and performance associated with mobile radio communication, in particular within operations of each cell compared to another cell, tend to change in time and space due to various reasons, such as weather conditions, the number of communication devices, radio signal interference, relative location of radio access nodes to terminal devices, terrain, etc. Furthermore, operator preferences may also affect such conditions, as, for example, communication conditions obtained based on an operator preference towards power conservation may not be the same for communication conditions obtained based on another operator preference towards data throughput.

Training of an AI/ML may cause operational costs, for example in terms of bandwidth as the entity implementing the AI/ML may need to exchange data for the purpose of obtaining training data to be used to train the AI/ML, and/or in terms of computation costs and power consumption, as the entity implementing the AI/ML may need to train the AI/ML multiple times within a period of time. Accordingly, while a training based on RAN operations of each cell may increase the operational costs associated with the operation of the AI/ML, a training that is superficial, namely only with common features of all the cells may increase estimation and/or prediction errors. It may be desirable to implement a training, in particular an online training, which is selective of RAN-related data of a plurality of cells, such that the training is based only on subset cells of the plurality of cells, at least for a particular period of time.

In other words, a device providing an RRM service may collect RAN-related data of tens, hundreds, or even thousands of cells, and such collected RAN-related data may be used to train one or more AI/MLs. Each cell may have particular characteristics, and these characteristics may be represented by cell-specific parameters. Training of such an AI/ML may be based on RAN-related data collected from all the cells, which may lead to a high amount of data aggregation and corresponding enormous compute for training the AI/ML. As an alternative, such AI/ML may be trained per cell (i.e. each performed training is based on RAN-related data of a single cell of the plurality of cells, which may still lead to high compute overhead and multiple model storage overhead. It may be desirable to improve the efficiency of the training of the AI/ML.

RAN-related data of a cell, as defined herein, may include any type of information that is representative of the operation of the radio access network service provided by the network access node of the cell. The RAN-related data may include information representative of the performance or the resource utilization of the radio access network within the cell. In some aspects, RAN-related data of a cell may include RAN telemetry data that may encompass at least one of various performance metrics (radio communication, device computation, energy consumption, etc.), user equipment (UE) data for which the UEs are served by the network access node of the cell, channel quality indicators associated with radio communication channels with the UEs, traffic data within the cell (i.e. data communicated (received or transmitted) by the respective network access node, mobility data, and spectrum usage information. In some aspects, RAN-related data of a cell may include RAN monitoring data that may encompass data gathered from observing and measuring different aspects of the RAN, such as at least one of the radio network performance within the cell, behavior of the UEs served by the respective network access node (UE behavior), patterns of network traffic within the cell, and cell-specific parameters of the cell. In some additional aspect, RAN-related data may include RAN operational data of the cell, which is related to the functioning and performance of the RAN, which the RAN-operational data may encompass at least one of radio access network metrics, UE information of the UEs served by the respective network access node, channel quality indicators (CQIs) of the UEs, traffic and mobility data, spectrum usage, and cell-specific factors. Each example provided herein may be referred to as an attribute of RAN-related data. RAN-related data may also be referred to as RAN data.

The skilled person would acknowledge that the actual structure and form of the RAN-related data, which is to be used as a basis for forming training input data that is to be used to train an AI/ML, may be based on the constraints associated with the training of the AI/ML, and may change depending on the use case. In some aspects, RAN-related data of a cell may include information representative of at least one of: one or more network performance metrics including data related to the performance of the RAN, such as throughput, latency, connection success rate, and dropped call rate; UE data that may include information about the terminal devices connected to the respective network access node, including UE capabilities, signal strength, and quality of service (QOS); Channel Quality Indicator (CQI) including a measure of the quality of the radio link between the UE and the respective network access node, which may help to determine the appropriate modulation and coding schemes for data transmission; traffic data that may include information about the types and volumes of data traffic within the cell (i.e. with the network access node), such as voice, video, and data applications, which may impact network congestion and resource allocation; mobility data including data related to the movement of terminal devices connected to the respective network access node, including the frequency of handovers, cell reselections, and other mobility events, which can influence network stability and performance; spectrum usage data including information about the allocation and utilization of frequency bands within the RAN provided by the respective network access node, which can affect capacity and interference levels; and/or cell-specific parameters.

The RAN-related data may include, in particular, key performance metrics (key performance measures, key performance measurements, key performance indicators, collectively to be referred to as “KPMs”) including cell-level performance measurements (e.g. performance measurements for gNB) defined in 3GPP specification TS 28.552 (e.g. TS 28.552, version 18.2.0) for 5G networks and TS.32.425 for EPC networks, and their possible adaptation of UE-level or QoS flow-level measurements, and any KPMs defined in O-RAN Working Group 3 Near-Real-time RAN Intelligent Controller E2 Service Model (E2SM) KPM (e.g. O-RAN.WG3.E2SM-KPM-R003-v03.00). It may include measurements of at least one of Throughput, Delay, Data volume, In-session activity time, PDCP drop rate, IP latency, Radio resource utilization, RRC connections related, PDU sessions related, DRBs related, QoS flows related, Mobility management, CQI related, MCS related, PEE related, Distribution of Normally/Abnormally Released Calls, DL Transmitted Data Volume, UL Transmitted Data Volume, Distribution of Percentage of DL Transmitted Data Volume to Incoming Data Volume, Distribution of Percentage of UL Transmitted Data Volume to Incoming Data Volume, Distribution of DL Packet Drop Rate, Distribution of UL Packet Loss Rate, DL Synchronization Signal based Reference Signal Received Power (SS-RSRP), DL Synchronization Signal based Signal to Noise and Interference Ratio (SS-SINR), UL Sounding Reference Signal based Reference Signal Received Power (SRS-RSRP).

Cell-specific parameters of a cell may include any type of information representative of an attribute or a feature associated with the cell, which the attribute or feature influences the performance of the behavior of the cell. Cell-specific parameters may be referred to as “cell configuration”, “cell context information” or “cell environment characteristics”. Cell-specific parameters may include information representative of at least one of: geolocation including the physical location of the cell, which may include its latitude, longitude, and altitude, which can impact radio signal propagation and coverage; topography of the cell including the terrain surrounding the cell, such as hills, valleys, or flatlands, which can affect radio signal propagation and potential interference; an Urban or a rural setting which may indicate the population density and types of structures (residential, commercial, or industrial) surrounding the cell, which can influence radio signal propagation, interference, and user demand; building materials and obstacles which may include the presence of buildings or other physical barriers, and the materials they are made of, which can attenuate radio signals and create multipath propagation effects; infrastructure including the availability and quality of power, backhaul, and other supporting infrastructure, which can impact the overall performance of the cell; spectrum allocation and usage which may include the frequency bands allocated to the cell, and their current usage, which can affect the capacity and interference levels within the cell, such as UE distribution, a number of UEs in an RRC connected state, a number of active UEs, reference signal strength indicator (RSSI) associated with the UEs, reference signal receive power (RSRP) associated with the UEs, CQI summaries of the UEs; UE distribution that may include the spatial distribution and density of user devices within the cell, which can impact resource allocation, signal strength, and user experience; traffic patterns which may include the types and volumes of data traffic within the cell, such as voice, video, and data applications, which can impact network congestion and resource allocation, such as downlink traffic, uplink traffic, physical resource block (PRB) usage, data throughput; and/or mobility patterns that may indicate the movement of users within the cell, including the frequency of handovers, cell reselections, and other mobility events, which can influence network stability and performance. Each example provided herein may be referred to as an attribute of cell-specific parameters.

It is to be noted that, some of the attributes defined as RAN-related data and some of the attributes defined as cell-specific parameters may include an overlap. The skilled person would recognize that the reason of the overlap may be due to the fact that the training of a particular AI/ML may also require cell-specific parameters as a block, or a particular data items needed from the cell-specific parameters. In practice, the RAN-related data and cell-specific parameters may be collected by an entity (e.g. near-RT RIC, the device 350) and stored in a memory (e.g. RAN database defined in O-RAN).

In accordance with various aspects provided herein, a network access node (e.g. the first network access node 301a and/or the second network access node 302a) determine various information that may fall under RAN-related data or cell-specific parameters of the respective cell based on operations and performance of the RAN. All network access nodes within the mobile communication network may accordingly provide their respective RAN-related data and respective cell-specific parameters, and the device 350 may accordingly obtain the RAN-related data and the cell-specific parameters of the cells 310a-d, 320a-d.

As the conditions associated with mobile radio communication tend to change in time and space within the coverage of each cell, it may be desirable to update the trained AI/ML in order to take the changed conditions into account. One of the assumptions in inferencing using trained AI/ML models is that the training and test distribution are similar. Therefore, to maintain the accuracy and precision of the AI/ML in time, it may be desirable to update the trained AI/ML models according to the operations of the cells 310a-d, 320a-d via further training.

It is particularly to be considered that RAN environment, and thereby operations and performance of the RAN provided by each cell is dynamic with respect to space and time. In a mobile communication network including multiple cells, some cells may be similar to each other based on certain measures or metrics defined in accordance with specified features and/or attributes. For example, a first cell 310a may be similar to a second cell 320a, with respect to certain key performance measures (KPMs), additionally or alternatively both cells may be, for example, have the same features (e.g. near highways, or in downtown) which may show similar time dynamics for these KPMs. In accordance with various aspects provided herein, the device 350 may select one or more cells, as subset cells, from the cells 310a-d, 320a-d, which the subset cells may represent a similar cell environment. The device 350 may calculate similarity measures according to cell-specific parameters. Accordingly, instead of training the AI/ML with RAN-related data of all of the cells 310a-d, 320a-d, the device 350 may cause the AI/ML to be trained with RAN-related data of the subset cells, thereby reducing the cost associated with data collection and computation overhead required for the training of the AI/ML.

In some aspects, the device 350 may select the subset cells based on an identified bias with respect to the RRM outputs and/or an identified data imbalance. The device 350 may accordingly determine certain parameters from cell-specific parameters for each cell to be used in the similarity calculation, and select the subset cells according to the determined parameters from the cell-specific parameters of the cells 310a-d, 320a-d. A simple illustrative example may be that the device 350 may identify a bias in the AI/ML for RRM outputs used for the cells that are near highways, and the device 350 may select cells that are near highways from the cells 310a-d, 320a-d, based on the cell-specific parameters, and cause the AI/ML to be trained with RAN-related data of the cells that are near highways to overcome the bias. This example is solely provided for illustration, and further aspects are provided in this disclosure, which are associated with bias or data imbalance. Accordingly, the device 350 may cause the AI/ML to be trained with a targeted approach to overcome the bias or data imbalance.

Exemplarily, determination of a subset of cells from a plurality of cells may result in selectively sampling data for RRM operations directed to the plurality of cells and may result in a common AI/ML that has been trained on the limited subset of data from the subset of cells, which may represent a similar radio communication environment, in particular with respect to the attributes of cell-specific parameters. Accordingly, the amount of data collection and compute required for training may be reduced. Further, only a small portion of the plurality of cells may demonstrate predetermined or predefined characteristics of the RAN-related, for example bias for RRM operations of the mobile communication network may arise from a scenario in which large number of cells operate in a low load region (e.g. below a designated threshold) as compared to minority cells in high load regime (e.g. above a designated threshold). Based on the objective of the RRM algorithm and preferred operations range, appropriate cells may be selected (representing diverse data) to reduce the data collection/training, and while taking into account these characteristics of the limited cells maintaining reasonable AI/ML performance.

FIG. 4 shows an example of a device 400 according to various examples in this disclosure. The device 400 may be a device (e.g. the device 350) of a mobile communication network, which the device 400 may obtain data of a plurality of cells (e.g. 310a-d, 320a-d). The device 400 is depicted as a communication device in this illustrative example, including a processor 401, a memory 402, and a communication interface 403 configured to receive and transmit communication signals in order to communicate with further entities within the mobile communication network. The communication interface 403 may include one or more transceivers. The processor 401 may include one or more processors, which may include a baseband processor and an application processor. In various examples, the processor 401 may include a central processing unit, a graphics processing unit, a hardware acceleration unit (e.g. one or more dedicated hardware accelerator circuits (e.g., ASICs, FPGAs, and other hardware)), a neuromorphic chip, and/or a controller. The processor 401 may be implemented in one processing unit, e.g. a system on chip (SOC), or a processor. In accordance with various examples, the processor 401 may further provide further functions to process received communication signals. The memory 402 may store various types of information required for the processor 401, or the communication interface 403 to operate in accordance with various aspects of this disclosure.

The memory 402 may be configured to store cell data 404 representative of cell-specific parameters of a plurality of cells, as exemplarily defined in accordance with FIG. 3. The processor 401 may have obtained the cell data 404 based on its operations by communicating with the network access nodes via the communication interface 403. The operations of the device 400 may include that each network access node provides at least a portion of the cell data 404, which the network access nodes serve terminal devices within the plurality of cells, and the device 400 may receive cell-specific parameters of each cell from a respective network access node. In some examples, the processor 401 may have obtained cell data from another entity (e.g. another device) within the mobile communication network, which the another entity may communicate with the network access nodes. The device 400 may receive cell-specific parameters from the another entity. For example, the processor 401 may decode various messages received from network access nodes, which each decoded message of a particular cell may include one or more data items of the cell data 404, which the one or more data items are representative of one or more cell-specific parameters of the particular cell.

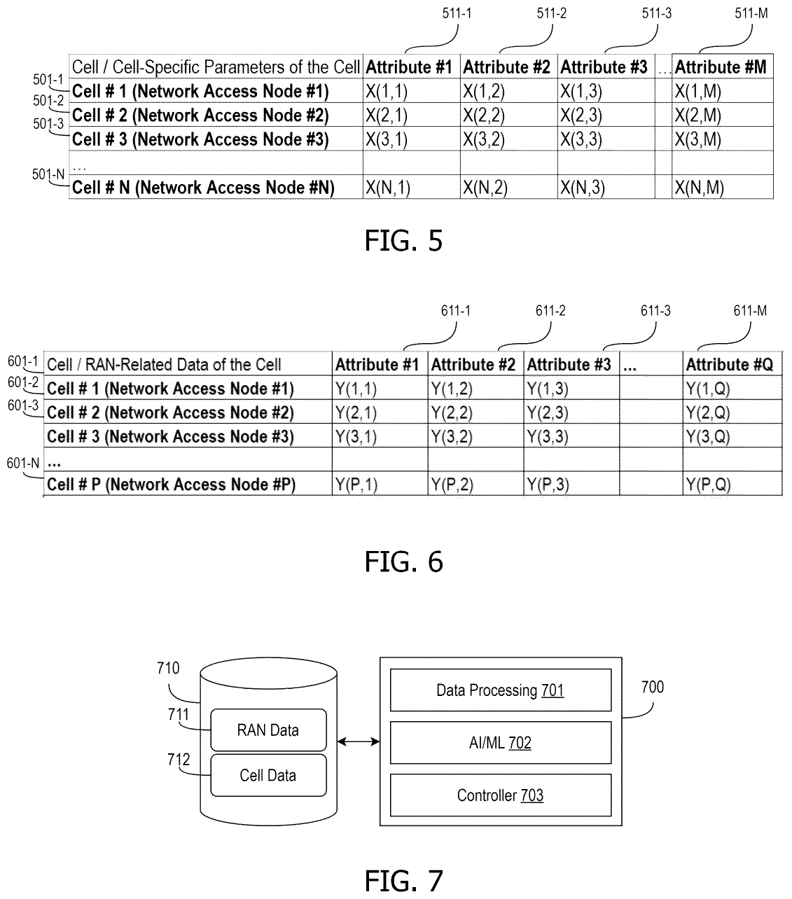

FIG. 5 shows an exemplary illustration of cell data (e.g. cell data 404) stored in a memory (e.g. the memory 402). As illustrated herein, the cell data may include cell-specific parameters of a plurality of cells (501-1, 501-2, 501-3, . . . , 501-N). Each cell is associated with a network access node providing network access service for the cell. The cell data may include cell specific parameters for each cell. For example, the cell data, for a first cell 501-1, may include cell-specific parameters of the first cell. The cell-specific parameters, for the first cell 501-1, may include a first attribute 511-1 (e.g. a mobility parameter) represented by a first parameter X(1,1) (e.g. a parameter representing user movement patterns in the first cell 501-1), a second attribute 511-2 (e.g. geolocation) represented by a second parameter X(1,2) (e.g. a parameter representing the location of the first cell 501-1), a third attribute 511-3 (e.g. topography) represented by a third parameter X(1,3) (e.g. a parameter representing the terrain of the first cell 501-1), and such, up to an M-th attribute represented by an M-th parameter X(1,M). Similarly, the cell data includes cell-specific parameters of a second cell 501-2, a third cell 501-3, and such, up to an N-th cell. M and N are integers greater than 3.

The memory 402 may be configured to store RAN data 405 representative of RAN-related data of multiple cells, as exemplarily defined in accordance with FIG. 3. The processor 401 may have obtained the RAN-related data 404 based on its operations by communicating with the network access nodes via the communication interface 403. The operations of the device 400 may include that each network access node provides at least a portion of the cell data 404, which the network access nodes serve terminal devices within the plurality of cells, and the device 400 may receive RAN-related data of each cell from a respective network access node. In some examples, the processor 401 may have obtained RAN-related data from another entity (e.g. another device) within the mobile communication network, which the another entity may communicate with the network access nodes. The device 400 may receive RAN-related data from the another entity. For example, the processor 401 may decode various messages received from network access nodes, which each decoded message of a particular cell may include one or more data items of the RAN data 405, which the one or more data items are representative of RAN-related data of the particular cell.

FIG. 6 shows an exemplary illustration of RAN-related data (e.g. RAN data 405) stored in a memory (e.g. the memory 402). As illustrated herein, the RAN data may include RAN-related data of a plurality of cells (601-1, 601-2, 601-3, . . . , 601-N). Each cell is associated with a network access node providing network access service for the cell. The RAN data may include RAN-related data for each cell. For example, the RAN data, for a first cell 601-1, may include RAN-related data of the first cell. The RAN-related data, for the first cell 601-1, may include a first attribute 611-1 (e.g. a network performance metric) represented by a first parameter Y(1,1) (e.g. a data throughput metric of the first cell 601-1), a second attribute 611-2 (e.g. another network performance metric) represented by a second parameter Y(1,2) (e.g. a latency metric of the first cell 601-1), a third attribute 611-3 (e.g. data traffic) represented by a third parameter Y(1,3) (e.g. data representing types and volumes of data traffic of the first cell 601-1), and such, up to a Q-th attribute represented by a Q-th parameter X(1,Q). Similarly, the RAN data includes RAN-related data of a second cell 601-2, a third cell 601-3, and such, up to a P-th cell. P and Q are integers greater than 3.

It is to be noted that FIG. 6 illustrates an example of RAN data 405. In view of aspects of this disclosure involving selecting a subset from a plurality of cells, the RAN data 405 may include RAN-related data of only the selected subset of the cells. In some aspects, assuming the selected subset of cells are cells of first network access nodes, and the cells that are not selected from the plurality of cells are cells of second network access node, the device 400 may cause the second network access nodes not to provide RAN-related data, which may reduce data communication in the mobile communication network. The processor 401 may encode messages carrying information representing that RAN-related data of the respective network access node is not needed, or required, or expected, to transmit the second network access nodes.

In some examples, the device 400 may cause only the first network access nodes to provide RAN-related data. The processor may encode messages carrying information representing that RAN-related data of the respective network access node is needed, required, or expected, to transmit the first network access nodes. In some examples, the processor 401 may control the communication interface to receive RAN-related data only from the first network access nodes. The processor 401 may accordingly schedule radio resources to receive RAN-related data only from the first network access nodes, at least for a designated period of time.

Alternatively, or additionally, the RAN data 405 may include RAN-related data of the plurality of cells. After the determination, by the processor 401, of the subset cells from the plurality of cells, the processor 401 may only use RAN-related data of the selected subset cells within the RAN data 405. The processor 401 may accordingly access the memory to obtain RAN-related data of the selected subset cells. Accordingly, the RAN data 405 stored in the memory 402 may still include the RAN-related data of all of the plurality of cells, but the processor 401 may use only a portion of the RAN data 405 for aspects involving training, which may result in reduction of computing resources and other resources associated with the training.

In various examples, the processor 401 may obtain the cell data 404 and the RAN data 405 via the communication interface 403 by communicating with one or more other entities within the mobile communication network, and the one or more other entities may have obtained the respective information, as defined herein. In particular, the processor 401 may decode data (i.e. data used as cell data 404 or RAN data 405) received from the network access nodes store the decoded data appropriately as cell data 404 or RAN data 405 based on the attribute. It is further to be noted that cell data 404 and/or RAN data 405 stored in the memory may be dynamic, i.e. changing in time, as the device 400 receives data which network access nodes update in time during their operation. As the processor 401 receives such data, the processor 401 may update corresponding data items of the cell data 404 and/or RAN data 405, as these data items are subject to an update or a change. The device 400 may, via the communication interface 403, receive such data as a stream. The RAN data 405 and/or the cell data 404 stored in the memory 402, may include preprocessed data based on received stream of data. In some aspects, the RAN data 405 and/or the cell data 404 may be result of a performed feature extraction of the received data.

In some aspects, the device 400 may be an entity of the mobile communication network of a disaggregated RAN architecture, which the device 400 may communicate with the network access nodes. In some aspects, within O-RAN context, the device 400 may include a RIC, such as a near real-time RIC or a non-real-time RIC. In other words, the device 400 may be a device that may implement aspects of near-RT-RIC or non-RT-RIC. Accordingly, the processor 401 may implement various operations of a near-RT-RIC or a non-RT-RIC, and the memory 402 may store data required to perform near-RT-RIC or non-RT-RIC operations, some of which are described in this disclosure.

The aspects provided herein may include the use of AI/ML-based RRM algorithms. Such RRM algorithms may employ one or more AI/MLs to obtain RRM outputs. Aspects will be described here for an AI/ML, but they also apply to the use of more than one AI/MLs. In some aspects, in which the AI/ML is implemented by another entity, the device 400 may include a controller entity, and the AI/ML model may be implemented by a RIC (a near-RT-RIC or a non-RT-RIC). The device 400 may accordingly communicate with the RIC. In some aspects, the AI/ML used to provide RRM outputs for the plurality of cells may be implemented by an external device that is external to the device 400. Accordingly, the processor 401 may encode/decode messages, exchanged with the external AI/ML implementing device, carrying information some of which are disclosed herein. The messages may include model information including information representative of various features of the AI/ML. For example, some aspects provided herein may include determinations based on model information representative of capabilities and/or requirements associated with the AI/ML, such as minimum performance requirements for the AI/ML, which are collectively to be referred as constraints of the AI/ML. The performance requirements for the respective AI/ML may be represented by various performance requirement parameters based on the respective algorithm (e.g. classification, regression, etc.) employed by the respective AI/ML. In case the one or more AI/ML is also implemented by the device 400, the processor 401 may obtain the model information from the memory 402. In some aspects, the model information may include one or more cell selection criteria.

The model information may include, for an AI/ML, parameters associated with a confusion matrix, a precision metric parameter, and/or a precision metric, for an AIML employing a classification algorithm, while the model information may include parameters associated with a mean absolute error, a mean square error, or an r squared metric for an AI/ML model employing a regression algorithm. The parameters of the model information may include parameters defining a minima, a maxima, a threshold, etc. for the respective performance metric. Furthermore, the model information may include information representative of a performance metric, in particular such as one of a measure of power consumption (e.g. an average or a maximum amount of power consumption), a measure of use of computation resources (e.g. an average or a maximum amount of use of computation resources, a measure of power consumption (e.g. an average or a maximum amount of power consumption), etc. Further, the model information may include information representative of constraints or limitations for data aggregation (i.e. data aggregation requirements). The model information may include a weighting parameter associated with the performance or cost of operation associated with the use of the respective AI/ML (e.g. for training or for inference). The model information may include information representative of constraints or limitations associated with input data required for the respective AI/ML, such as information (e.g. attributes of RAN-related data) to be included in the input data, data structure, etc.

Furthermore, some aspects provided herein may include determinations based on operator information representative of preferences of a mobile network operator (MNO) associated with the mobile network service provided by the cell. The MNO may prefer a radio resource management prioritizing power conservation over data throughput, or a radio resource management prioritizing data throughput over power conservation. Moreover, the MNO may also provide various limitations associated with the AI/ML. The operator information may include, in particular, one or more thresholds associated with the constraints of the AI/ML. The operator information may include a number of cells to be selected as the subset cells. The operator information may include a weight representative of an optimization choice for implementation of the one or more AI/ML in terms of performance metrics of the AI/ML. For example, the weight may represent a weight between the accuracy of the AI/ML and the allocation of computation resources for the AI/ML. The operator information may define the plurality of cells. In some examples, the operator information may include one or more cell selection criteria.

In accordance with various aspects provided herein, the device 400 may communicate via the communication interface 403 with an entity of the mobile communication network, which the entity may provide the operator information including information representative of above-mentioned preferences of the MNO. The entity that provides the operator information may be an orchestrator entity of the mobile communication network (e.g. a service management and orchestration (SMO) entity in O-RAN).

The processor 401 may select subset cells from the plurality of cells based on the cell data 404. The plurality of cells may include the cells for which the AI/ML provide RRM outputs. The number of cells of the plurality of cells are smaller than the number of cells of the selected subset cells. The ratio of the numbers may be P %, P being an integer between 0 and 99. The operator information may define the number of cells of the selected subset. The processor 401 may determine the number of cells of the selected subset based on at least one of the model information, the operator information, and/or the cell data 404.

In some aspects, the processor 401 may select the subset cells based on the model information. The model information may include information representative of exemplary cells from the plurality of cells. The entity implementing the AI/ML (either the processor 401 or the external device) may have determined the exemplary cells as the cells that are used as a template for selecting subset cells according to the operation of the AI/ML (e.g. based on data imbalances identified for cells or performance metrics of the AI/ML).

The processor 401 may determine the exemplary cells from the plurality of cells based on one or more cell selection criteria. The model information or the operator information may provide the one or more selection criteria. The one or more cell selection criteria may include information representative of one or more attributes and a parameter associated with each attribute, which the parameter may be a value, a range, a mapping operation with respect to the respective attribute, etc. The one or more attributes of the cell selection criteria may correspond to attributes provided in the cell data 404. The processor 401 may determine the exemplary cells based on the one or more cell selection criteria and the cell data 404, exemplarily selecting cells as exemplary cells according to the one or more cell selection criteria from the cell data 404.

In some aspects, the processor 401 may determine the exemplary cells from the plurality of cells iteratively by adding a cell of the plurality of cells into the set of exemplary cells. After each iteration of adding a cell, the processor 401 may determine an RRM output performance metric representative of the performance of the AI/ML after the training with that added cell, and at a next iteration of adding a cell, the processor 401 may select the cell to be added at the next iteration based on the RRM output performance metric.

The number of exemplary cells may be predetermined and may be small, such as E, E being an integer between 3 and 50. The processor 401 may select the subset cells which the number of the subset cells are smaller than the plurality of cells but greater than the number of exemplary cells. The processor 401 may select the subset cells from the plurality of cells, which the selected subset cells are determined to be similar to the exemplary cells.

The processor 401 may determine whether a cell from the plurality of cells is similar to the exemplary cells based on cell-specific parameters of the cell and cell-specific parameters of at least one of the exemplary cells. In some aspects, the processor 401 may have determined the subset cells by comparing each cell of the subset cells and the at least one of the exemplary cells. The processor 401 may determine the subset cells based on comparisons comparing cach cell of the plurality of cells and the at least one of the exemplary cells. It is to be recognized that the subset cells would eventually include the exemplary cells, and accordingly the processor 401 may skip performing comparisons including the exemplary cells with themselves and/or with each other.

In order to cause the AI/ML to be trained with the RAN data of the selected subset cells, the processor 401 may communicate information representative of the selected subset cells to the entity implementing the AI/ML (or to the AI/ML unit as described in this disclosure), and the AI/ML may obtain RAN-related data of the selected subset cells as training input data. In particular, when the AI/ML is implemented by the device 400, the processor 401 may simply send a control signal or control information to a controller of the AI/ML that triggers a training operation with the RAN-related data of the selected subset cells. When the AI/ML is implemented by another entity, the processor 401 may encode the information representative of the selected subset cells. The processor 401 may be further configured to train the AI/ML with the RAN data of the selected subset cells.

In some aspects, the processor 401 may further generate a training dataset for the AI/ML, which the training dataset includes aggregated RAN-related data of the selected subset cells. The processor 401 may aggregate the RAN-related data of the selected subset cells to form the training dataset. The training dataset may include training input data including RAN-related data of the selected subset cells. It is to be considered that the training of the AI/ML may include an offline training, namely by adjusting initialized model parameters of the AI/ML, or may include online training (which may be also referred to as “incremental training” or “optimizing”), namely by adjusting model parameters stored in a memory (e.g. the memory 402).

The device 400 may implement the AI/ML. The device 400 may be a computing device or an apparatus suitable for implementing the AI/ML. The processor 401, or another processor as provided in this disclosure may implement the AI/ML. According to various aspects of this disclosure, other types of AI/ML implementations may include a further processor that may be internal or external to the processor (e.g.an accelerator, a graphics processing unit (GPU), a neuromorphic chip, one or more dedicated hardware accelerator circuits (e.g., ASICs, FPGAs, and other hardware), etc.), or a memory may also implement the AI/ML. The AI/ML may be configured to provide RRM outputs based on input data and Model parameters (model parameters). The AI/ML may include a trained AI/ML, in which the Model parameters are configured according to a training process for the purpose of providing respective RRM outputs in accordance with received input data based on the RAN data. A trained AI/ML may include an AI/ML which is trained prior to an inference to obtain RRM outputs. A trained AI/ML may further include an AI/ML which is trained based on the RRM outputs obtained via AI/ML (i.e. optimizations). In various aspects, Model parameters include parameters configured to control how the input data may be transformed into RRM outputs. Model parameters may further include hyperparameters configured to control how the AI/ML performs learning (e.g. learning rate, number of layers, classifiers, etc.).

FIG. 7 shows an example of a processor and a memory of a device according to various aspects provided in this disclosure. The processor 700 is depicted to include various functional units that are configured to provide various functions as disclosed herein, associated with a processor (e.g. the processor 401) that may be used within a device (e.g. the device 400). The skilled person would recognize that the depicted functional units are provided to explain various operations that the processor 700 may be configured to perform. Similarly, the memory 710 is depicted to include the RAN data 711 (e.g. the RAN data 405) and the cell data 712 (e.g. cell data 404) as a block, however, the memory may store the RAN data 711 and the cell data 712 in any kind of suitable configuration or mechanism. Furthermore, the AI/ML unit 702 is depicted as it is implemented in the processor 700 only as an example, and any type of AI/ML implementation which may include the implementation of the AI/ML in an external processor, such as an accelerator, a graphics processing unit (GPU), a neuromorphic chip, or in a cloud computing device, or in an external communication device may also be possible according to any methods.

The processor 700 may include a data processing unit 701 that is configured to process data and obtain at least a portion of the RAN data 711 and the cell data 712 as provided in various examples in this disclosure to be stored in the memory 710. In various examples, the RAN data 711 and/or the cell data 712 may include not only current but also past information for at least within a period of time in a plurality of instances of time (e.g. as a time-series data). The RAN data 711 and/or the cell data 712 stored in the memory 710, may include preprocessed data based on received stream of data. In some aspects, the RAN data 711 and/or the cell data 712 may be result of a performed feature extraction of the received data. The data processing unit 701 may be configured to process corresponding data of respective cells received from respective network access nodes (i.e. “Received Data”) and form the RAN data 711 and the cell data 712.

The data processing unit 701 may implement various preprocessing operations to obtain the RAN data 711 and/or the cell data 712. Such operations may include cleaning the Received Data by removing outliers, handling of missing parameters, correcting errors or inconsistencies, and such. Operations may further include data normalizations in order to scale Received Data to a common range. Operations may further include data transformation including mapping Received Data based on predefined mapping operations corresponding to mathematical functions to map one or more data items of the Received Data to a mapped data time for the purpose of analysis.

The data processing unit 701 may be configured to generate training dataset based on the RAN data 711 and/or the cell data 712. In other words, based on the selected subset cells, the data processing unit may prepare the training data to be used in the training of the AI/ML. The data processing unit 701 may be configured to select data from the RAN data 711 and/or the cell data 712 based on the selected subset cells, exemplarily by selecting data from the RAN data 711 and/or the cell data 712, which the selected data is of the selected subset cells. The selection of the data may include sampling the RAN data 711 and/or the cell data 712 to select data only of the selected subset cells. Such data is to be referred to as “Selected Data”.

The generation of the training dataset may include aggregating the Selected Data. The data processing unit 701 may be configured to apply data fusion techniques to aggregate data. Data fusion may be considered as a process of integrating and combining data, within this context, by combining the RAN data 711 and/or the cell data 712 of the selected subset cells to obtain a unified dataset representative of the RAN environment, which in accordance with aspects of this invention, including the plurality of cells, not only the selected subset cells. The aspects provided herein include treating this particular aggregation of the data of the selected subset cells of the plurality of cells as if it represents the RAN environment for the plurality of cells.

The data processing unit 701 may further implement feature extraction operations. It is to be considered that the AI/ML implemented by the AI/ML unit may have certain constraints, some of which may relate to the structure and aspects of the data to be inputted to the AI/ML. The feature extraction operations may include translating (i.e. transforming) the RAN data 711 and/or the cell data 712 into input data of the AI/ML. The feature extraction operations may further include generation of training input data for the training dataset based on the RAN data 711 and/or the cell data 712. In some aspects, the feature extraction operations may be based on model information representing the attributes to be used as the input of the AI/ML, relative importance or weights of the attributes, etc. The feature extraction operations may include reducing the number of attributes (i.e. data items from the RAN data 711 and/or the cell data 712) to be used, ranking of the attributes, etc. based on the model information.

In some aspects, the RAN data 711 and/or the cell data 712 may include information representative of annotations and/or labels to be used for training. In some aspects, the data processing unit 701 may also assign labels or assign ground truth values for the Selected Data for the generation of the training dataset. In some aspects, the data processing unit 701 may further generate annotations for the generation of the training data set. Generation of annotations and/or labels may be according to supervised training inputs, or may be based on unsupervised methods, exemplarily by an implementation of an automatized model to assign the labels and/or the annotations.

For supervised learning, generation of labels and annotations may require domain expertise and an understanding of the specific RRM tasks that the AI/ML is designed to address. For example, a human expert might need to review network logs and performance data to identify instances of network congestion, which could then be labeled as positive or negative examples for a congestion prediction model. In some cases, semi-supervised or unsupervised learning techniques can be used to reduce the reliance on labeled data and leverage the vast amounts of unlabeled data available in the RAN. These approaches may involve clustering, anomaly detection, or other methods that can identify patterns and relationships in the data without explicit ground truth labels.

Accordingly, the data processing unit 701 may generate the training dataset based on the RAN data 711 and/or the cell data 712 of the cells of the selected subset. It is to be noted that the AI/ML unit 702 may use the training dataset in predefined portions, namely a first portion of the training data set for training, a second portion of the training dataset for validation and a third portion of the training dataset for testing purposes. The AI/ML unit 702 may use the first portion to train the AI/ML, which may allow the AI/ML to learn the underlying patterns and relationships in the data. The AI/ML unit 702 may use the second portion to evaluate and fine-tune the AI/ML during the training process, which may help to prevent overfitting and improve generalization. Finally, the AI/ML unit 702 may use the third portion to assess the performance of the trained AI/ML and provide an unbiased estimate of their accuracy and effectiveness for RRM tasks.

The AI/ML unit 702 may implement one or more AI/MLs. The aspects are provided for one AI/ML but it may also include applications involving more than one AI/MLs. The AI/ML may be configured to receive input data with certain constraints, features, and formats. Accordingly, the data processing unit 701 may obtain input data, that is based on the RAN data 711 and optionally on the cell data 712, to be provided to the AI/ML to obtain an output of the AI/ML (i.e. RRM output). In various examples, the data processing unit 701 may provide input data including the RAN data 711 to the AI/ML. The input data may include attributes of the RAN data 711 associated with a period of time or a plurality of consecutive periods of time. In various examples, the data processing unit 701 may convert the RAN data 711 to an input format suitable for the AI/ML (i.e. feature extraction e.g. to input feature vectors) so that the AI/ML may process the RAN data 711.

The processor 700 may further include a controller 703 to control the AI/ML unit 702. The controller 703 may provide the input data to the AI/ML, or provide the AI/ML unit 702 instructions to obtain the output. The controller 703 may further be configured to perform further operations of the processor 700 or the device associated with the processor in accordance with various aspects of this disclosure.

The AI/ML may be any type of machine learning model configured to receive the input data and provide an output as provided in this disclosure. The AI/ML may include any type of machine learning model suitable for the purpose. The AI/ML may include a decision trec model or a rule-based model suitable for various aspects provided herein. The AI/ML may include a neural network. The neural network may be any type of artificial neural network. The neural network may include any number of layers, including an input layer to receive the input data, an output layer to provide the output data. A number of layers may be provided between the input layer and the output layer (e.g. hidden layers). The training of the neural network (e.g., adapting the layers of the neural network, adjusting Model parameters) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain AI/ML (e.g. weights) parameters adjusting the input information.

The AI/ML may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, and processing, and estimations using time series data.

An LSTM network may include a network of LSTM cells that may process the attributes provided for an instance of time as input data, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input data. The LSTM network may process the features of the received raw data and determine a label for an attribute for each instance of time according to the features. The output data may include or represent a label associated with the input data.

In various examples, the neural network may be configured in top-down configuration in which a neuron of a layer provides output to a neuron of a lower layer, which may help to discriminate certain features of an input.

In accordance with various aspects, the AI/ML may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input data for a reinforcement learning model may include information representing a state, and an output data may include information representing an action.

Reinforcement learning (RL) is a type of machine learning that focuses on training an agent to make decisions by interacting with an environment. The agent learns to perform actions to achieve a goal by receiving feedback in the form of rewards or penalties. As a machine learning model, reinforcement learning models learn from data (in this case, the agent's experiences and interactions with the environment) to adapt their behavior and improve their performance over time. Since machine learning is a subset of AI, reinforcement learning models are also considered AI models, as they aim to perform tasks that require human-like decision-making capabilities.

The AI/ML may include a convolutional neural network (CNN), which is an example for feed-forward neural networks that may be used for the purpose of this disclosure. in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The AI/ML may include a generative neural network. The generative neural network may process input data in order to generate new sets, hence the output data may include new sets of data according to the purpose of the AI/ML. In various examples, the AI/ML may include a generative adversarial network (GAN) model in which a discrimination function is included with the generation function, and while the generation function may generate the data according to model parameters of the generation function and the input data, the discrimination function may distinguish the data generated by the generation function in terms of data distribution according to model parameters of the discrimination function. In accordance with various aspects of this disclosure, a GAN may include a deconvolutional neural network for the generation function and a CNN for the discrimination function. The AI/ML may include a trained AI/ML that is configured to provide the output as provided in various examples in this disclosure based on the input data and one or more Model parameters obtained by the training. The trained AI/ML may be obtained via an online and/or offline training. A training agent may perform various operations with respect to the training at various aspects, including online training, offline training, and optimizations based on the inference results. The AI/ML may take any suitable form or utilize any suitable technique for training process. For example, the AI/ML may be trained using supervised learning, semi-supervised learning, unsupervised learning, or reinforcement learning techniques.

In supervised learning, the AI/ML may be obtained using a training dataset including both inputs and corresponding desired outputs (illustratively, input data may be associated with a desired or expected output for that input data). Each training instance may include one or more input data item and a desired output. The training agent may train the AI/ML based on iterations through training instances and using an objective function to teach the AI/ML to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the Model parameters of the respective model based on outputs and inputs (i.e. output data and input data). The training agent may train the AI/ML according to the desired outcome. The training agent may provide the training data to the AI/ML to train the AI/ML. In various examples, the processor and/or the AI/ML unit itself may include the training agent, or another entity that may be communicatively coupled to the processor may include the training agent and provide the training data to the device, so that the processor may train the AI/ML.

In various examples, the device may include the AI/ML in a configuration that it is already trained (e.g. the Model parameters in a memory are already set for the purpose). It may desirable for the AI/ML itself to have the training agent, or a portion of the training agent, in order to perform optimizations according to the output of inferences as provided in this disclosure. The AI/ML may include an execution unit and a training unit that may implement the training agent as provided in this disclosure for other examples. In accordance with various examples, the training agent may train the AI/ML based on a simulated environment that is controlled by the training agent according to similar considerations and constraints of the deployment environment.

For example, the training dataset may include training input data based on RAN data 711 and/or the cell data 712 of the selected cells, which may include information representative of one or more attributes described in this disclosure. Each training input data item may include one or more attributes of a cell of the selected subset cells. Training input data may further include training output data associated with the training input data representing desired outcomes with respect to each set of training input data. Training output data may indicate, or may represent, the desired outcome with respect to training input data, so that the training agent may provide necessary adjustments to respective Model parameters in consideration of the desired outcome. In some aspects, the training output data may include labels and annotations as described here.

The skilled person would immediately recognize that the exemplary AI/ML disclosed herein is explained that may have many configurations. In a least complex scenario, for execution of the AI/ML (i.e. inference), the AI/ML may be configured to provide an RRM output parameter to be used by the plurality of cells. The input data of the AI/ML may include one or more attributes of one or more cells provided in the RAN data 711. The AI/ML may map the input data to a corresponding RRM output parameter, which the mapping would be based on model parameters of the AI/ML. For training of the AI/ML, the training agent may train the AI/ML by providing training input data of the generated training dataset to the input of the AI/ML and it may adjust model parameters of the AI/ML based on the output of the AI/ML that is mapped according to the training input data, and training output data of the training dataset (e.g. labels, annotations) associated with the provided training input data with an intention to make the output of the AI/ML more accurate. Accordingly, the training agent may adjust one or more model parameters based on a calculation including parameters for the output of the AI/ML for the training input data and the training output data associated with the training input data. In various examples, the calculation may also include one or more parameters of the AI/ML. With each iteration with respect to the training input data that may include many data items, which each data item may represent an input of an instance (of time, of observation, etc.) on various aspects and cach iteration may iterate a respective data item representing an input of an instance, the training agent may accordingly cause the AI/ML to provide more accurate output through adjustments made in the model parameters.

The processor 700 may implement the training agent, or another entity that may be communicatively coupled to the processor 700 may include the training agent and provide the training input data to the device, so that the processor 700 may train the AI/ML. The training agent may be part of the AI/ML unit 702 described herein. Furthermore, the controller 703 may control the AI/ML unit 702 according to a predefined event. For example, the controller 703 may provide instructions to the AI/ML unit 702 to perform the inference and/or training in response to a received request from another entity. The controller 703 may further obtain output of the AI/ML from the AI/ML unit 702.

In accordance with some of the aspects provided herein, the controller 703 may control the AI/ML unit 702 to selectively cause the AI/ML to be trained in a first operation mode and a second operation mode. In the first operation mode, the training agent (e.g. the AI/ML unit 702) may cause the AI/ML to be trained with a first training dataset that is generated, which the first training dataset includes the RAN data 711 and/or the cell data 712 of only the selected subset cells of the plurality cells. In the second operation mode, the training agent (e.g. the AI/ML unit 702) may cause the AI/ML to be trained with a second training dataset including the RAN data 711 and/or the cell data 712 of at least one cell of the plurality of cells, which the at least one cell is not within the selected subset cells. In accordance with the operation mode, the data processing unit 701 may perform necessary operations to generate respective training datasets. The data processing unit 701 may generate the second training dataset in accordance with known methods by aggregating the RAN data 711 for the plurality of cells (i.e. the second training dataset includes aggregated data of all of the plurality of cells), or selectively by aggregating the RAN data 711 of a selection of the cells, which the selection of the cells includes at least one cell is not within the selected subset cells.

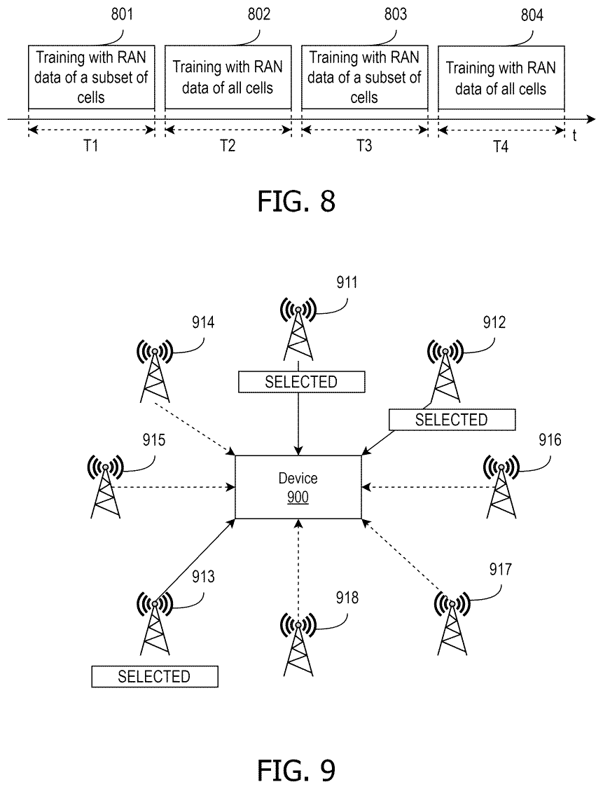

FIG. 8 shows an exemplary illustration of training an AI/ML in accordance with various aspects provided herein. A controller (e.g. the controller 703) may cause a training unit (e.g. training unit of the AI/ML unit 702) to train the AI/ML selectively in a first operation mode and a second operation mode as defined above. In the first operation mode, the controller may cause the AI/ML to be trained with RAN data of subset cells that are selected from a plurality of cells. In the second operation mode, the controller may cause the AI/ML to be trained with RAN data of the plurality of cells.

In the first operation mode, the controller may further control a data processing unit (e.g. the data processing unit 701) to generate training dataset including RAN data of the subset cells selected from the plurality of cells. In the second operation mode, the controller may control the data processing unit to generate training dataset including RAN data of the plurality of cells.

In some aspects, the controller may further control data reception in accordance with the operation mode. In order to obtain RAN data to be used in the first operation mode, the controller may control a communication circuitry (e.g. the communication circuitry 403) to receive RAN data of the subset cells selected from the plurality of cells. Furthermore, in order to obtain RAN data to be used in the second operation mode, the controller may control the communication circuitry to receive RAN data of the plurality of cells. It is to be considered that the control of the communication circuitry may cause the communication circuitry to obtain the RAN data from designated cells (i.e. from the subset of the plurality of cells in the first operation mode and from the plurality of cells in the second operation mode) by scheduling communication resources to receive the RAN data from the designated cells. Alternatively, or additionally, the communication circuitry 403 may send a message representative of a request to obtain the RAN data from designated sets (i.e. from the subset of the plurality of cells in the first operation mode and from the plurality of cells in the second operation mode). In some aspects, control of the communication circuitry may also correspond to the operation mode in which the device operates.

In this illustration, the controller may cause the device (e.g. the device 400) to operate in the first operation mode for a first period of time (T1), in which the controller cause the AI/ML to be trained 801 with RAN data of a subset of a plurality of cells. After the first period of time, the controller may cause the device to operate in the second operation mode for a second period of time (T2), in which the controller cause the AI/ML to be trained 801 with RAN data of the plurality of cells. Durations T1 and T2 may be predefined or predetermined.

Furthermore, the controller may cause the device to operate back in the first operation mode for a third period of time (T3), in which the controller cause the AI/ML to be trained 801 with RAN data of a subset of a plurality of cells. The subset may be the same subset used in the first period of time (T1), or it may be a different subset selected in accordance with various aspects provided herein. After the third period of time, the controller may cause the device to operate in the second operation mode for a fourth period of time (T4), in which the controller cause the AI/ML to be trained 801 with RAN data of the plurality of cells. Durations T3 and T4 may be predefined or predetermined. In one example all durations of T1, T2, T3, T4 may be equal. In some examples, the controller may determine the durations based on operator information representative a preference of an operator representative of a weight. Particularly, T1 and T3 may be greater than T2 and T4 respectively. The controller may cause the AI/ML to be trained in the first operation mode more frequently than the controller causes the AI/ML to be trained in the second operation mode.

FIG. 9 shows an exemplary illustration of communication paths between network access nodes and a device in accordance with various aspects provided herein. A device 900 (e.g. the device 400) may obtain RAN data and cell-specific parameters of a plurality of cells 911-918. A processor of the device may have selected cells 911, 912, 913 from the plurality of cells, which the selected cells 911, 912, 913 correspond to selected subset cells. The plurality of cells may be considered to further include remaining cells 914-918 which are not selected.

In some examples (e.g. FIG. 8), the device 900 may communicate, in the first operation mode, with the selected cells 911, 912, 913 to receive RAN data of the selected cells. In the second operation mode, the device 900 may communicate with the plurality of cells 911-918 to receive RAN data of the plurality of cells. By arranging the durations which the device 900 operates in respective operation modes, the device 900 may perform its operations by a designated balance between the performance of AI/ML based RRM algorithms and communication overhead (e.g. amount of data traffic to communicate RAN data). In some aspects, the balance may be represented by a mapping operation representing a predefined objective mathematical function. The predefined objective mathematical function may provide mapping to maximize an object of a performance metric of the AI/ML (or AI/ML based RRM algorithm) and a data collection metric (e.g. amount of data traffic) or training metric (e.g. a training cost metric).

In some examples, the processor of the device 900 may cause RAN data of the selected cells 911-913 continuously. Further, the processor of the device may cause the RAN data of the remaining cells 914-918 intermittently. Exemplarily, in both the first operation mode and the second operation mode, the processor may sample the RAN data of the selected cells 911-913 in a continuous manner, and the processor may sample the RAN data of the remaining cells 914-918 only in the second operation mode.

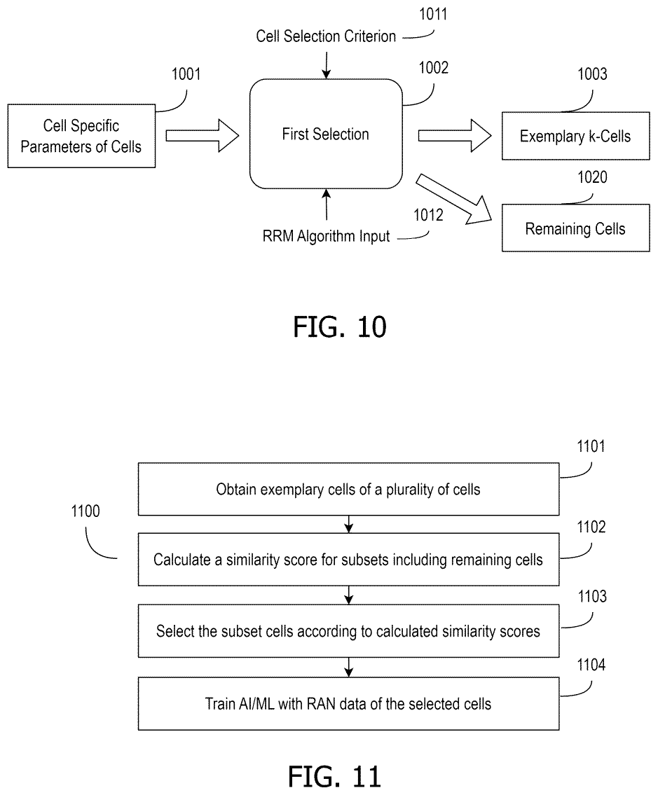

FIG. 10 shows an exemplary illustration of selecting exemplary cells from a plurality of cells, performed by a processor (e.g. the processor 400, the processor 700). The processor may obtain cell-specific parameters 1001 of a plurality of cells. An exemplary data representative of cell-specific parameters is provided in FIG. 5. The processor may perform a first selection 1002 to obtain k number of exemplary cells 1003. The number of k may be predefined or predetermined (e.g. k=5). It is to be considered that, the number k may be taken defined with a number smaller than 10 (e.g. 5) to form a task with relatively lower complexity. The cells that are not selected as the exemplary cells may be referred to as remaining cells 1020.

In some examples, the processor may determine, for each cell of the plurality of cells, whether the cell meets one or more cell selection criteria 1011. As described herein, a cell selection criterion may include a value, a range, or a mapping operation, of an attribute provided in the cell-specific parameters 1001. The processor may determine, for each cell, whether the cell meets one or more cell selection criteria 1011 based on one or more attributes of the cell-specific parameters of the cell and corresponding cell selection criterion. The processor may simply take the first k cells. Each cell of the first k cells meets the one or more cell selection criteria. The processor may cease further analysis when such first k cells are identified. In an illustrative example, the cell selection criterion may be that the load of the cell being low (e.g. below a threshold), and the processor may, by comparing cell load attribute of each cell with the cell selection criteria (i.e. threshold), determine the exemplary cells as the first k-cells with the low cell load attribute.

In some examples, the processor may receive information from the RRM algorithm using the respective AI/ML, which the received information may indicate the exemplary cells. For example, the RRM algorithm may detect an imbalance associated with a particular type of cells (e.g. cells with low load) and the RRM algorithm may provide a set of cells. In some examples, the RRM algorithm may provide k-number of cells, or alternatively the processor may select arbitrarily from the cells that the RRM algorithm provides.

In some examples, the processor may determine the exemplary cells, by incrementally adding a cell to the exemplary k-cells, namely by adding a cell at each iteration to the set of exemplary cells. The processor may then calculate a performance score which may be representative of an increase of gain based on the exemplary cells and the change of performance of the RRM algorithm in response to that particular set of exemplary cells. By performing this operation iteratively, the processor may determine the set of exemplary cells resulting the highest incremental gain in the performance of the RRM algorithm.

FIG. 11 shows an exemplary procedure including selecting cells from a plurality of cells. A processor (e.g. the processor 401, the processor 700) may perform the procedure 1100. The procedure 1100 may begin with obtaining 1101 exemplary cells of a plurality of cells. Various examples are provided in accordance with FIG. 10 including performing a first selection based on a cell selection criterion or based on an RRM algorithm input. The exemplary cells are intended to provide a basis to proceed with the subset selection. Aspects may include any method of selection of cells from the plurality of cells based on the exemplary cells, in accordance with the nature of the AI/ML-based RRM algorithm, in particular in accordance with constraints of the AI/ML used by the RRM algorithm in terms of AI/ML performance metrics and cost of training metrics (i.e. costs in terms of computation and/or communication).

In this exemplary procedure, the processor may calculate 1102 similarity scores for different subsets of the plurality of cells, in which each calculated similarity score may be representative of a similarity between designated cell-specific parameters of the cells of the respective subset and cell-specific parameters of the exemplary cells. It is particularly to be considered to take into account that the subset that is to be selected in the next step of the procedure should be similar to the set of the exemplary cells. It is further to be considered that the cells in each subset should have a designated diversity, so that the information to be provided to the AI/ML with the training is not repeated. Ideally, each subset includes a cell only one time, i.e. each subset does not include the same cell twice. In some examples, the calculation 1102 of similarity scores may include calculating, with a predefined mapping operation that is configured to calculate a correlation between cell-specific parameters of each subset and the set of exemplary cells, correlation values.

In accordance with some aspects, the processor may calculate 1102 similarity scores using a particular mutual information measure, in consideration with the aspects provided in the paragraph above. The mutual information measure may be defined as the following I(A,Q), I being the mutual information measure of a set of cells A (i.e. subset of the plurality of cells) to be determined as the subset cells and the set of exemplary cells Q. S denoting a predefined mapping operation to map i-th attribute of cell-specific parameters of the cells in the set A and corresponding j-th attribute of cell-specific parameters of the cells in the set Q to a similarity value representative of the similarity between these features of the cell-specific parameters; I(A, Q)=Σ_{i∈A}Σ_{j∈Q}S_{i,j}

It is to be considered that the information measure I(A,Q) is a submodular function in set A, meaning that adding an element to a smaller set A would result in a higher gain in the information measure than adding it to a larger set A. The processor may determine the set A that maximizes the information measure I(A,Q) while maintaining a cardinality constraint on A (e.g., |A|<b). Since the information measure is a submodular function, the processor may use a greedy approach by adding cells from the remaining cells into the set A one by one while following the cardinality constraint and the objective increases. In this iterative approach, the processor may cease adding a new cell from the remaining cells into the set A, in response to a determination that the benefit of adding a cell is below a threshold. In response to the determination, the processor may select the set A as the selected subset cells.

In other words, the information measure I(A, Q) being a submodular function would lead to diminishing returns. Accordingly, as the processor adds more cells into the set A, the marginal gain in the information measure decreases. This property of submodularity is important because it allows for the use of a greedy algorithm to approximate the optimal solution efficiently. In the context of the method described, the goal is to maximize the information measure I(A, Q) while keeping the size of set A below a designated threshold (|A|<b), where b is the cardinality constraint. The greedy approach to solving this problem works as follows: i) Start with an empty set A or with a set including only the exemplary cells. ii) For each cell of the remaining cells that is not already in set A, calculate a marginal gain in the information measure (I(A, Q)) that would result from adding that cell to set A. iii) Select the cell that provides the highest marginal gain in the information measure and add it to set A. provided that the cardinality constraint is not violated (|A|<b). Repeat steps ii and iii until there is no additional benefit (or no benefit above a threshold) in adding more cells to set A, or until the cardinality constraint is reached. The greedy algorithm works well in this case because the submodularity of the information measure ensures that the locally optimal choice at each step (i.e., choosing the cell that provides the highest marginal gain) leads to a solution that is close to the globally optimal solution. This allows for an efficient and effective method for selecting a subset of cells that maximizes the information measure while adhering to the cardinality constraint.

The processor may further select 1103 the subset cells according to the calculated similarity scores. That may be considered as the final selection of the subset cells (i.e. set A) in case the information measure I(A,Q) is used. The selection 1103 may further be based on model information representative of the computation constraints and/or data transfer constraints associated with the AI/ML. Exemplarily, the selection 1103 may include a selection from the determined subset of cells in accordance with the information measure I(A,Q). In consideration with the model information representing the constraints of the AI/ML, the selection 1103 may decrease the number of cells of the selected subset of cells by eliminating some of the cells from the set A. Exemplarily, assuming the set A includes 200 cells and the processor determines to limit the number of selected subset cells into 170, the processor may remove the last added 30 cells from the set A to obtain the selected subset cells.

In some aspects, the selection 1103 operation may further include arranging cells in the set A in an order and shortlisting the cells. As the selected subset cells are identified, the data from the corresponding ells may be used to train the AI/ML model. Accordingly, exponential complexity in finding an appropriate cell subset to train the AI/ML may be avoided, and the training may be performed more effectively for optimal network operations. The processor may further train 1104 the AI/ML based on RAN data of the cells that are within the selected subset cells.

It is to be noted that, in a performed simulation including aspects provided in FIG. 11 for a network of 450 cells and for an AI/ML-based RRM algorithm involving a load prediction for switching off cells when the expected load is low, service level agreement (SLA) outage caused by incorrect load prediction using a mean squared loss function is calculated. For an exemplary cells of 5 cells in high load region, it is found that load prediction in high load regime is critical. In this context, in a scenario 1: training the AI/ML with RAN-related data of one cell has resulted in 4.2% SLA outage. In a scenario 2: training the AI/ML with RAN-related data of 10 cells has resulted in 3.8% SLA outage. In a scenario 3: training the AI/ML with RAN-related data of 20 cells has resulted in 2.66% SLA outage. In a scenario 4: training the AI/ML with RAN-related data of 50 cells has resulted in 2.4% SLA outage. In a scenario 5: training the AI/ML with RAN-related data of 100 cells has resulted in 2.9% SLA outage. In a scenario 6: training the AI/ML with RAN-related data of all 450 cells has resulted in 3% SLA outage. By selecting 50 cells from 450 cells, 20% gain is recognized in terms of performance (SLA outage) (i.e. 2.4% SLA outage vs 3% SLA outage) and the costs of data aggregation and training overhead are reduced 9 times (processing data of 50 cells/processing data of 450 cells).

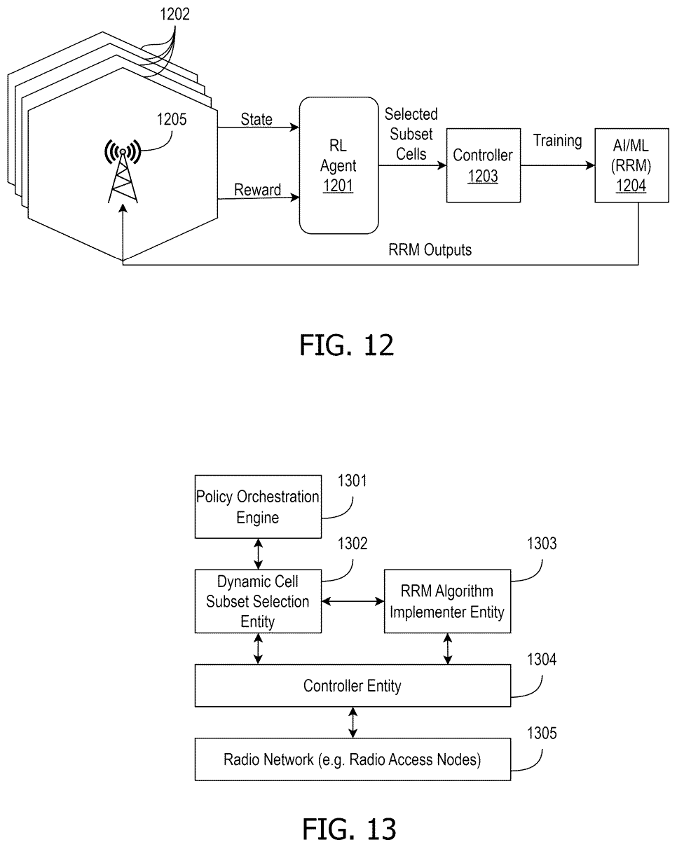

FIG. 12 shows an exemplary representation of a reinforcement learning (RL) model based AI/ML, that a processor (e.g. the processor 401, the processor 700) may implement. The processor may determine a subset of cells from a plurality of cells using an RL model. A reinforcement learning agent (RL agent) 1201 (e.g. the AI/ML unit 702) may determine an action based on a first observation (i.e. state) made for the observation environment and model parameters of the RL model. An observation may be the state represented by cell-specific parameters of a plurality of cells 1202 served by respective network access nodes 1205 at a first instance of time. In this illustrative example, cell-specific parameters may exemplarily include, for each cell, downlink/uplink PRB usage, mobility, number of terminal devices that are in RRC_Connected mode within the respective cell, number of active terminal devices (e.g. that use radio resources over a predefined threshold), channel quality information for radio communication channels between respective network access node 1205 and terminal devices (e.g. user channel quality summary provided by the network access node 1205), time of the day, etc. These are provided only as examples, and any attribute of cell-specific parameters may be used. It is to be noted that such cell-specific parameters may be designated based on the nature of the AI/ML based RRM algorithms.

The RL agent 1201 may also obtain a first reward for the first instance of time with respect to a transition from a previous instance of time to the first instance of time, that may be represented by the first observation. Actions that the RL agent 1201 may include defining a subset of cells from the plurality of cells. In some aspects, in particular considering the presence of a set of obtained exemplary cells, actions may include adding a remaining cell to a set of cells defined for the action implementations of the RL. In other words, in each action iteration, the RL agent may add a remaining cell into the set of cells or remove a cell from the set of cells. In some examples, the removed cell may be the last cell that has been added in a previous iteration.

For example, the RL agent 1201 may determine an action which may include a adding of one of the remaining cells into the set of cells. Based on the nature of the RL model, the selection of the remaining cell to be added into the set of cells may be arbitrary. In some aspects, the selection of the remaining cell to be added into the set of cells may be based on a greedy approach, i.e. by adding the remaining cell which has the highest estimated reward based on the last observation. Initially, the set of cells only includes the exemplary cells and as the iterations of the RL agent 1201 performed, remaining cells are added into the set of cells.

The RL agent 1201 may, based on the first observation, map the state represented with the first observation (i.e. the cell data at a first instance of time) to one of the remaining cells that maximizes the reward according to the estimation of the RL agent 1201 based on the model parameters of the RL model. Accordingly, the RL agent 1201 may output a selected subset cells to a controller 1203 (e.g. the controller 703). The controller 1203 may cause the AI/ML (of an RRM algorithm) 1204 to be updated (to be re-trained or further trained) with a training using a training data set including RAN-related data of the selected subset cells. Accordingly, the AI/ML 1204 may be trained with RAN-related data of the selected subset cells and perform inferences that provide RRM outputs to manage radio resources of the plurality of cells 1202. Accordingly, the state observable by the RL agent 1201 changes into a second instance of time.

At a second instance of time, the RL agent 1201 may obtain a second reward with respect to management of the plurality of cells 1202 using the RRM outputs that are based on the AI/ML that has been trained using RAN-related data of the selected subset cells for the transition from the first instance of time to the second instance of time. Based on the second reward, the RL agent 1201 may update the model parameters of the RL model to be used for a further action (i.e. adding a remaining cell into the set of cells or removing the last added cell from the set of cells) that may be based on a second observation at the second instance of time or a further instance of time. The second observation may be based on the state represented by updated cell-specific parameters of the cells 1202. With each iteration for a new state and reward associated with the transition to the new state, the RL agent 1201 may learn or optimize the policy used to map the observations to the action of adding a remaining cell into the set of cells or removing the last added cell from the set of cells.

In one example, the reinforcement learning model may be based on Q-learning to provide the output in the particular state represented by the input according to a Q-function based on Model parameters. The Q-function may be represented with an equation: Q_{new} (sₜ, aₜ)←(1−α)Q(sₜ,aₜ)+α(r+γmaxa(Q(sₜ₊₁,a)) such that, s representing the state (observation) and a representing an action of adding a remaining cell into the set of cells or removing the last added cell from the set of cells, representing all state-action pairs (observation-selected update timescale pairs) with an index t, the new Q value of the corresponding state-action pair t is based on the old Q value for the state-action pair t and the sum of the reward r obtained by adding a particular remaining cell into the set of cells or removing the last added cell from the set of cells aₜ in the state sₜ with a discount rate y that is between 0 and 1, in which the weight between the old Q value and the reward portion is determined by the learning rate α.

The discount factor may determine the importance of future rewards. A discount factor of 0 can make the agent “myopic” (or short-sighted) by only considering current rewards, while a factor close to 1 can make the agent strive for a long-term high reward. If the discount factor meets or exceeds 1, the action values may diverge, γ=1, all environment histories can become infinitely long, and utilities with additive, undiscounted rewards generally become infinite. Even with a discount factor only slightly lower than 1, Q-function learning leads to propagation of errors and instabilities when the value function is approximated with an artificial neural network. In that case, starting with a lower discount factor and increasing the discount value towards a final value may accelerate the learning.

In relation to the classification associated with the action set using Q-learning the reward may be optimal a performance metric of the AI/ML 1204 (e.g. data throughput) and a cost metric of the AI/ML 1204 (e.g. overhead (i.e. the compute overhead or power consumption overhead)). One way of implementing Q-learning may include using Q-tables. The RL-agent 1201 may use a Q table with initial values as Os or any other value. The states may include the cell-specific parameters. During the training of the RL agent 1201, Q table is updated with appropriate values. During the inferencing phase, the actions of adding a remaining cell into the set of cells or removing the last added cell from the set of cells are inferred from the Q-table.

The RL agent 1201 may accordingly, based on an observation representative of cell-specific parameters after the management of the radio resources according to the determined set of cells, update expected rewards (e.g. update a reward function, or update Q-table) for learning. Furthermore, based on the observations representing the state, the RL agent 1201 may add a remaining cell into the set of cells or remove the last added cell from the set of cells that maximizes the expected reward based on the reward function or Q-table.

In various examples, the reward function or Q-table may include parameters based on predetermined performance metrics, such as total cell throughput of the cells 1202 and overhead (i.e. power consumption overhead and/or compute overhead). An exemplary reward function may be formulated as Rᵢ=w₁*P_{1,i}−w₂*P_{2,i} where Rᵢ denotes the reward of i-th transition from an instance of time to another instance of time, P_{1,i} denotes the first measured performance metric for the i-th transition, P_{2,i} denotes the second measured performance metric for the i-th transition, and w₁ and w₂ denote weights for the first measured performance metric and the second measured performance metric respectively. By arranging the respective weights, an optimum balance may be desired. In accordance with various aspects, the processor may set the respective weights based on operator information representative of the preference of MNO. Accordingly, in various examples, the observations associated with a transition from an instance of time to another instance of time may further include performance information representative of data throughput of the cells 1202 according training with RAN-related data of previously determined set of cells, and overhead information representative of power consumption overhead or compute overhead obtained to manage radio resources of the cells according to produced RRM outputs.

In accordance with various aspects of this disclosure, the RL may include a multi-armed bandit reinforcement learning model. In multi-armed bandit reinforcement learning models, the model may test available actions (e.g. adding a remaining cell into the set of cells or removing the last added cell from the set of cells) at substantially equal frequencies. With each iteration, the RL agent 1201 may adjust the machine learning model parameters to select actions that are leading better total rewards with higher frequencies at the expense of the remaining selectable actions, resulting in a gradual decrease with respect to the selection frequency of the remaining selectable actions, and possibly replace the actions that are gradually decreased with other selectable actions. In various examples, the multi-armed bandit RL model may select the actions irrespective of the information representing the state. The multi-armed RL model may also be referred to as one-state RL, as it may be independent of the state.

Accordingly, with respect to examples provided in this section, the AI/ML may include a multi-armed bandit reinforcement learning model configured to select actions without any information indicating the state, in particular with an intention to explore rewards associated with adding a remaining cell into the set of cells or removing the last added cell from the set of cells according to a present state. It is to be recognized that the benefit obtained with arbitrary selection may have long-term benefits due to the learning of the associated outcome, but not for selecting the optimum action. In order to obtain a balance between exploring (e.g. arbitrary selection) and exploitation (e.g. adding a remaining cell into the set of cells or removing the last added cell from the set of cells that maximizes the reward according to current model parameters), the RL agent 1201 may be configured to perform an epsilon-greedy selection.

In accordance with various aspects provided herein, the AI/ML may include an RL model configured to perform an epsilon-greedy selection. The RL model may operate exemplarily as explained with respect to FIG. 12, with a difference in that the RL agent 1201 may select adding a remaining cell into the set of cells or removing the last added cell from the set of cells for exploration with a probability of ∈, and the RL agent 1201 may select adding a remaining cell into the set of cells or removing the last added cell from the set of cells from the plurality of update timescales for exploitation with a probability of 1-∈ that maximizes the reward. For this purpose, the processor may define ∈ to the RL agent 1201. In various examples, ∈ may be determined by the orchestrator entity of the mobile communication network within operator information.

FIG. 13 shows an exemplary illustration of various entities of a mobile communication network. It is to be noted that the exemplary illustration may indicate a logical structure, in which one or more of the entities of the mobile communication network 1300 may be implemented by the same physical entity, or a distributed physical entity (a plurality of devices operating collectively) may implement one of the entities of the mobile communication network 1300. A processor may implement various aspects of a logical node. The mobile communication network 1300 may include an orchestrator entity, a policy orchestration engine 1301 configured to oversee orchestration aspects, management aspects, and automation of RAN elements.

The policy orchestration engine 1301 may be configured to communicate with at least a dynamic cell subset selection entity 1302 that may include a device (e.g. the device 400) including a processor configured to select subset cells from a plurality of cells, in accordance with various aspects provided in this disclosure. The dynamic cell subset selection entity 1302 may communicate with at least an RRM algorithm implementer entity 1303 that is configured to implement an AI/ML configured to manage the radio resources of the plurality of cells of a radio network 1305.

In this illustrative example, the RRM algorithm implementer entity 1303 may also communicate with a controller entity 1304 that may configure and/or control radio resources of the radio network. The RRM algorithm implementer entity 1303 may receive data used to input to an AI/ML from the controller entity 1304 and the RRM algorithm implementer entity 1303 may provide RRM parameters based on inferences on the received data to the controller entity 1304. The controller entity 1304 may configure and/or control the radio network 1305 based on the RRM parameters received from the RRM algorithm implementer entity 1303 to manage radio resources of the radio network 1305. The radio network 1305 may include a plurality of radio access nodes (i.e. network access nodes) designated for the plurality of cells. and the controller entity 1304 may communicate with each radio access node to manage radio resources of a respective one or more cell of the plurality of cells.

Within this exemplary mobile communication network 1300, an application of an entity may be configured to perform various aspects provided herein for the respective entity. Applications associated with different entities may communicate with each other via application programming interfaces (APIs) to receive and/or send data, information, messages, etc. In this illustrative example, the RRM algorithm implementer entity 1303 may identify a presence of an entity that is configured to perform a cell subset selection operation, namely the dynamic cell subset selection entity 1302, via an API designated to identify an entity that is configured to perform the cell subset selection.

The RRM algorithm implementer entity 1303 may, optionally in response to the identification of the dynamic cell subset selection entity 1302, encode cell-specific parameters and/or RAN-related data of the plurality of cells, based on which the RRM algorithm implementer entity 1303 determines RRM parameters (i.e. RRM outputs) to send the encoded information to the dynamic cell subset selection entity 1302. Accordingly, the dynamic cell subset selection entity 1302 may obtain cell-specific parameters and RAN-related data based on received encoded information.

Alternatively, or additionally, the RRM algorithm implementer entity 1303, or the policy orchestration engine 1301, may send a request to the dynamic cell subset selection entity 1302 representative of a request for a cell subset selection from the plurality of cells. In response to receiving such a request, the dynamic cell subset selection entity 1302 may request cell-specific parameters and/or RAN-related data for the designated plurality of cells from the controller entity 1304. The controller entity 1304 may send encoded information associated with the designated plurality of cells to the dynamic cell subset selection entity 1302. Accordingly, the dynamic cell subset selection entity 1302 may obtain cell-specific parameters and RAN-related data based on received encoded information.

Furthermore, the dynamic cell subset selection entity 1302 may receive operator information from the policy orchestration engine 1301, and the operator information may represent one or more preferences of an MNO, in particular configurations and commands provided by the policy orchestration engine 1301 to configure cell subset selection performed by the dynamic cell subset selection entity 1302. The operator information may represent various information as provided in this disclosure (e.g. operator information), exemplarily an identifier for each cell or a group of cells forming the plurality of cells, an identifier for a respective RRM algorithm to be used by the RRM algorithm implementer entity in the mobile communication network 1300, one or more thresholds, limitations, or requirements for performance metrics (e.g. data throughput, compute overhead, etc.), weights associated for performance metrics for determination of update timescales for the respective one or more cells (i.e. w₁ and w₂). The dynamic cell subset selection entity 1302 may receive the operator information via an API designated to receive policies from the policy orchestration engine 1301.

Furthermore, the dynamic cell subset selection entity 1302 may receive model information from the RRM algorithm implementer entity 1303, and the model information may represent various attributes for the AI/ML, in particular, to configure the cell subset selection. The model information may represent various information as provided in this disclosure, including a set of exemplary cells (e.g. cell identifiers of the exemplary cells), capability and requirements with respect to the respective AI/ML such as minimum performance requirements of the respective AI/ML, maximum compute overhead for inference and/or training the respective AI/ML, input data structure, constraints, weighting factor for the respective performance metrics, an objective function used by the AI/ML, an objective function based on predefined performance metric parameters that may be a data throughput parameter and an overhead parameter, other key performance indicators (e.g. KPMs).

Accordingly, in accordance with various aspects provided in this disclosure, the dynamic cell subset selection entity 1302 may select a subset from the plurality of cells, the subset including some of the plurality of cells, based on cell-specific parameters of the plurality of cells of the radio network 1305. The dynamic cell subset selection entity 1302 may send information representative of the selected subset to the RRM algorithm implementer entity 1303, and the RRM algorithm implementer entity 1303 may perform training with a training dataset including RAN-related data of the cells within the subset, and determine further RRM outputs used to manage radio resources of the plurality of cells. The RRM algorithm implementer entity 1303 may include a training agent that is configured to re-train the respective AI/ML by first initializing model parameters of the respective AI/ML, and/or that is configured to further train the respective AI/ML by not initializing model parameters of the respective AI/ML (e.g. optimize the trained AI/ML). The training agent may update the respective AI/ML by re-training or by further training the respective AI/ML.

In some examples, the dynamic cell subset selection entity 1302 may operate as a training data repository that is configured to provide training datasets to the RRM algorithm implementer entity 1303. Accordingly, the dynamic cell subset selection entity 1302 may also generate training datasets based on its operations. In one example, that is not depicted herein, another entity within the network may operate as a data repository, which may store cell-specific parameters of the plurality of cells, RAN-related data of the plurality of cells, and the training dataset. The dynamic cell subset selection entity 1302 and the RRM algorithm implementer entity 1303 may communicate with the data repository to exchange information provided herein.

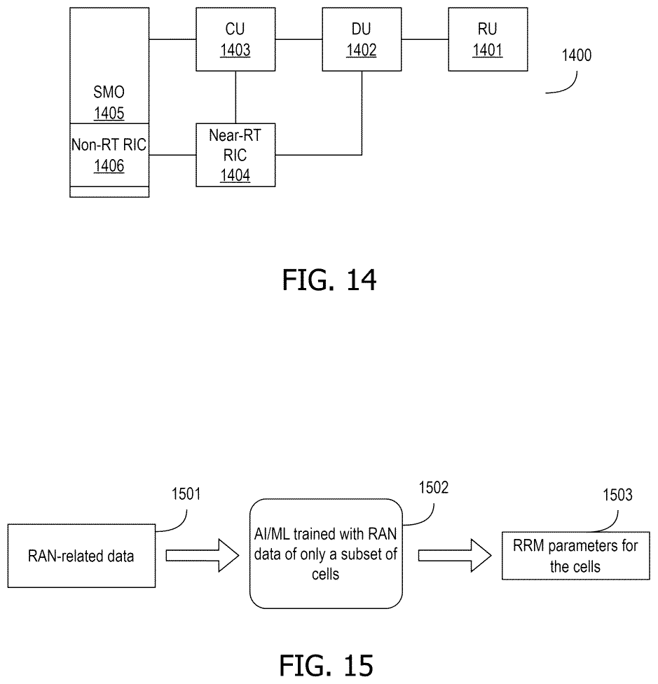

FIG. 14 shows an exemplary radio access network architecture in which the radio access network is disaggregated into multiple units. In LTE or 5G NR, network access nodes, such as a BS may implement the whole network stack including physical layer (PHY), media access control (MAC), radio link control (RLC), packet data convergence control (PDCP), and radio resource control (RRC) functions of the network stack. In a distributed approach of radio access networks, the processing of the network stack is disaggregated into at least two units (e.g. into RU, DU, and CU). Although the example illustrates a distributed structure that is based on open-RAN (O-RAN) architecture, the skilled person is able to populate the teaching provided herein in other types of distributed architectures, such as baseband unit (BBU) that may operate in the cloud and may be split to a Control Unit (CU) according to Rel.15 of 3GPP standards.

In various deployments in recently emerged RAN architectures, such as Open Radio Access Network (O-RAN) architectures, network access nodes may have functionalities that are split among multiple units with an intention to meet the demands of increased capacity requirements by providing a flexible and interoperable approach for RANs. The exemplary RAN 1400 provided herein includes a radio unit (RU) 1401, a DU 1402, a CU 1403, a near RT-RIC 1404, and a service management and orchestration framework (SMO) 1405 including a non-RT RIC 1406. The skilled person would recognize that the illustrated structure may represent a logical architecture, in which one or more of the entities of the mobile communication network may be implemented by the same physical entity, or a distributed physical entity (a plurality of devices operating collectively) may implement one of the entities of the mobile communication network provided herein.

There are many approaches to provide the split among the multiple units. In this illustrative example, the CU 1403 (e.g. O-CU) may be mainly responsible for non-real time operations hosting the radio resource control (RRC), the PDCP protocol, and the service data adaptation protocol (SDAP). The DU (e.g. O-DU) 1402 may be mainly responsible for real-time operations hosting, for example, RLC layer functions, MAC layer functions, and Higher-PHY functions. RUs 1401 (e.g. O-RU) may be mainly responsible for hosting the Lower-PHY functions to transmit and receive radio communication signals to/from terminal devices (e.g. UEs) and provide data streams to the DU over a fronthaul interface (e.g. open fronthaul). The SMO 1405 may provide functions to manage domains such as RAN management, Core management, Transport management, and the non-RT RIC 1406 may provide functions to support intelligent RAN optimization via policy-based guidance, AI/ML model management, etc. The near-RT RIC 1404 may provide functions for real time optimizations, including hosting one or more xApps that may collect real-time information (per UE or per Cell) and provide services, that may include AI/ML services as well.

The exemplary RAN 1400 is illustrated for the purpose of brevity. The skilled person would recognize the aspects provided herein and may also realize that the exemplary RAN 1400 may include further characterizations, such as the CU may also be-at least logically-distributed into two entities (e.g. CU-Control Plane, CU-User Plane), there may be various types of interfaces between different entities of the exemplary RAN 1400 (e.g. E2, F1, O1, X2, NG-u, etc.).

In accordance with the exemplary distributed RAN architecture, a UE may transmit radio communication signals to the RU 1401 and receive radio communication signals from the RU 1401. The processing associated with the communication is performed at the respective layers of the network stack by respective entities that are responsible to perform the corresponding function of the respective layers.

In accordance with various aspects of this disclosure and this exemplary RAN 1400, aspects associated with the management of radio resources may include MAC layer functions within the DU 1402. Accordingly, the DU 1402 may include aspects of a controller entity configured to manage radio resources in response to received RRM parameters (i.e. RRM outputs) provided herein and configured to manage radio resources for a communication via the communication channel that is established between the RU 1401 and a UE.

In accordance with various aspects of this disclosure and this exemplary RAN 1400, aspects associated with cells subset selection and implementation of AI/ML-based RRM algorithms for the determination of RRM parameters to be used to configure radio resources of the cells cell may be performed by functions of the near-RT RIC 1404. Accordingly, the near-RT RIC may include aspects associated with cells subset selection and implementation of AI/ML-based RRM algorithms, which the RRM parameters are used to manage the radio resources of the plurality of cells provided herein. In other words, the device (e.g. the device) described herein may operate as the near-RT RIC. In such an example, near-RT RIC 1404 may obtain information to perform subset selection and cause the AI/ML of the AI/ML-based RRM algorithms via the DU 1402, the CU 1403, or even via the RU 1401.

In accordance with various aspects of this disclosure and this exemplary RAN 1400, aspects associated with cells subset selection and implementation of AI/ML-based RRM algorithms (e.g. the device 400) may be performed by functions of the near RT-RIC 1404 or the non-RT RIC 1406. In a case that the aspects associated with cells subset selection and implementation of AI/ML-based RRM algorithms is implemented by the non-RT RIC 1406, the non-RT RIC 1406 may receive operator information from the SMO 1405, the non-RT RIC 1406 may perform cells subset selection and implementation of AI/ML-based RRM algorithms and exchange data with the near-RT RIC 1404. The non-RT RIC 1406 may receive RAN-related data and cell-specific parameters from the near-RT RIC 1404, or from the DU 1402, the CU 1403, and/or even from the RU 1401.

The near-RT RIC 1404 may receive the cell-specific parameters and RAN-related data from the DU 1402 or the CU 1403, and store the data in a storage (e.g. Radio parameters database). In some examples, the non-RT RIC 1406 may perform aspects associated with cells subset selection (i.e. cell subset selection entity) and the near-RT RIC 1404 may perform aspects associated with implementation of AI/ML-based RRM algorithms (i.e. RRM algorithms implementer entity). In some examples, the near-RT RIC 1404 may perform aspects associated with cells subset selection (i.e. cell subset selection entity) and the non-RT RIC 1406 may perform aspects associated with implementation of AI/ML-based RRM algorithms (i.e. RRM algorithms implementer entity).

FIG. 15 shows an example of an AI/ML in accordance with various aspects provided herein. The AI/ML 1502 may be trained with a training dataset including RAN-related data of only a subset of a plurality of cells as described herein. The AI/ML 1502 may be configured to receive input data 1501 that is based on RAN-related data of the plurality of cells, as provided in various aspects of this disclosure. The input data 1501 may include the RAN-related data and optionally the cell-specific parameters of at least one or some of the plurality of cells that are transformed into a format that is suitable as input data for the AI/ML 1502, such as input feature vectors associated for one or more attributes of the RAN-related data and optionally the cell-specific parameters.

The AI/ML 1502 may be configured provide an output 1503 that is indicative or representative of a parameter that is to be used in radio resource management of the plurality of cells. In an illustrative example, the output 1503 of the AI/ML 1502 may include a parameter of cell load balancing operation for distributing load between neighboring cells to prevent overloading and improve network efficiency. In another illustrative example, the output 1503 of the AI/ML 1502 may include handover parameters for handover decisions, such as thresholds and timing, to ensure seamless connectivity for mobile users. In another illustrative example, the output 1503 of the AI/ML 1502 may include inter-cell interference coordination parameters for minimizing interference between adjacent cells, improving network performance.

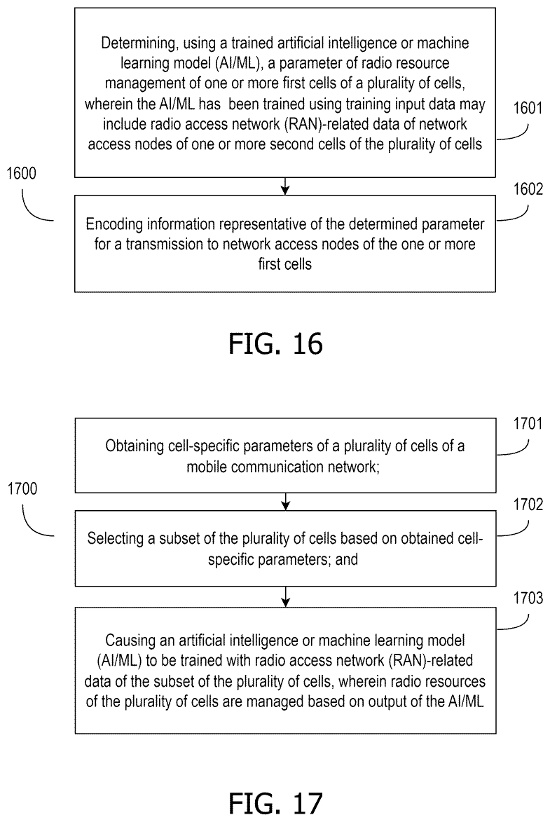

FIG. 16 shows an example of a method. The method 1600 may include determining 1601, using a trained artificial intelligence or machine learning model (AI/ML), a parameter of radio resource management of one or more first cells of a plurality of cells, wherein the AI/ML has been trained using training input data may include radio access network (RAN)-related data of network access nodes of one or more second cells of the plurality of cells; and encoding 1602 information representative of the determined parameter for a transmission to network access nodes of the one or more first cells.

FIG. 17 shows an example of a method. The method 1700 may include: obtaining 1701 cell-specific parameters of a plurality of cells of a mobile communication network; selecting 1702 a subset of the plurality of cells based on obtained cell-specific parameters; and causing 1703 an artificial intelligence or machine learning model (AI/ML) to be trained with radio access network (RAN)-related data of the subset of the plurality of cells, wherein radio resources of the plurality of cells are managed based on output of the AI/ML.

A non-transitory computer-readable medium may include one or more instructions which, if executed by a processor, cause the processor to perform exemplarily the methods outlined in FIGS. 15 and 16, or any aspects provided in this disclosure. The following examples pertain to further aspects of this disclosure.

In Example 1, the subject matter includes a device that may include: a processor configured to: obtain cell-specific parameters of the plurality of cells of a mobile communication network; select a subset of the plurality of cells based on obtained cell-specific parameters; and cause the AI/ML to be trained with radio access network (RAN)-related data of the subset of the plurality of cells. Optionally the subject matter further includes a memory. The memory may be configured to store an artificial intelligence or machine learning model (AI/ML) configured to provide an output used in radio resource management of a plurality of cells, or the memory may be configured to store the cell-specific parameters and/or the RAN-related data.

In Example 2, the subject matter of example 1, can optionally include that the processor is further configured to selectively cause the AI/ML to be trained with first data including the RAN-related data of the subset of the plurality of cells or cause the AI/ML to be trained with second data including RAN-related data of at least one or more cells that are not within the subset of the plurality of cells.

In Example 3, the subject matter of example 2, can optionally include that the processor is further configured to cause the AI/ML to be trained with the first data for a first period of time and cause the AI/ML to be trained with data including the second data for a second period of time.

In Example 4, the subject matter of example 2, can optionally include that the processor is further configured to cause the AI/ML to be trained with the first data more frequently than to cause the AI/ML to be trained with the second data.

In Example 5, the subject matter of example 2, can optionally include that the processor is further configured to cause the first data to be sampled continuously from first network access nodes of the subset of the plurality of cells and to cause the RAN-related data of the at least one or more cells that are not within the subset of the plurality of cells to be sampled intermittently from second network access nodes.

In Example 6, the subject matter of any one of examples 1 to 5, can optionally include that the processor is further configured to aggregate the RAN-related data of the subset of the plurality of cells to obtain training data used to train the AI/ML.

In Example 7, the subject matter of any one of examples 1 to 6, can optionally include that the processor is further configured to select the subset based on operator information representative of a preference of a mobile network operator.

In Example 8, the subject matter of example 7, can optionally include that the operator information includes information representative of at least one of usable priority cells, one or more performance thresholds associated with one or more performance metrics, a number of cells in the subset, one or more cost metrics, or a preference for optimization.

In Example 9, the subject matter of any one of examples 1 to 8, can optionally include that cell-specific parameters of each cell includes information representative of at least one of network traffic, downlink traffic, uplink traffic, physical resource block (PRB) usage, reference signal strength indicator (RSSI), reference signal receive power (RSRP), data throughput, mobility, user density, geolocation, topography, traffic patterns, user equipment (UE) distribution, a number of UEs in an RRC connected state, a number of active users, user channel quality summary, or UE density.

In Example 10, the subject matter of any one of examples 1 to 9, can optionally include that the processor is further configured to select the subset of the plurality of cells based on AI/ML information representative of features of the AI/ML.

In Example 11, the subject matter of example 10, can optionally include that the AI/ML information includes information representative of at least one of exemplary cells of the plurality of cells, a performance requirement of the AI/ML model, a computation requirement of the AI/ML model, a data aggregation requirement to train the AI/ML model, a weighting parameter associated with performance and cost of operation, a mapping associated with the performance of the AI/ML and the cost of operation of the AI/ML, one or more requirements associated with input data of the AI/ML.

In Example 12, the subject matter of any one of examples 1 to 10, can optionally include that the processor is further configured to determine exemplary cells of the plurality of cells based on a cell selection criterion.

In Example 13, the subject matter of any one of examples 1 to 10, can optionally include that the processor is further configured to determine exemplary cells of the plurality of cells iteratively by adding a cell of the plurality of cells into the exemplary cells of the plurality of cells and performance of the AI/ML output of the iterations.

In Example 14, the subject matter of any one of examples 10 to 13, can optionally include that the processor is further configured to calculate similarity scores for multiple subsets of the cells, each calculated similarity score is representative of a similarity between one or more cell-specific parameters of cells of a respective subset and one or more cell-specific parameters of the exemplary cells.

In Example 15, the subject matter of example 14, can optionally include that the similarity scores are calculated based on a similarity mapping operation.

In Example 16, the subject matter of example 15, can optionally include that the subset of the plurality of cells is selected from the plurality of subsets of the cells, which the subset maximizes a measure with a cardinality constraint for number of cells within each subset of the multiple subsets of the cells.

In Example 17, the subject matter of example 16, can optionally include that the subset of the plurality of cells is selected by using a greedy approach that maximizes the measure.

In Example 18, the subject matter of any one of examples 14 to 17, can optionally include that the measure being I, the processor is configured to select A being the subset of the plurality of cells according to Q being the exemplary cells with a cardinality constraint |A|<b based on the similarity mapping operation Si,j denoting the mapping between i-th cell-specific parameters of the A and j-th cell-specific parameters of the Q; and can optionally include that the greedy approach is used to identify the A that maximizes the I.

In Example 19, the subject matter of any one of examples 10 to 13, can optionally include that the processor is further configured to select the subset of the plurality of cells using a reinforcement learning model; can optionally include that a reward of the reinforcement learning (RL) model is based on a performance metric of the AI/ML and a cost metric of the AI/ML.

In Example 20, the subject matter of example 19, can optionally include that the processor is further configured to determine a state based on the cell-specific parameters of at least the exemplary cells; can optionally include that the processor is further configured to determine an action by adding one or more further cells from the plurality of cells to a set may include the exemplary cells.

In Example 21, the subject matter of example 20, can optionally include that the reward of the RL model includes a mapping operation including the performance metric of the AI/ML and the cost metric of the AI/ML that are weighed.

In Example 22, the subject matter of any one of examples 1 to 21, can optionally include that the processor is further configured to implement the AI/ML.

In Example 23, the subject matter of any one of examples 1 to 21, can optionally include that the AI/ML is implemented by a controller that is external to the processor; can optionally include that the processor is further configured to provide, to the controller, information representative of the subset of the plurality of cells; can optionally include that the controller is configured to train the AI/ML using the RAN-related data of the subset of the plurality of cells.

In Example 24, the subject matter of any one of examples 1 to 23, may further include a communication circuit configured to perform communications with network access nodes of the plurality of cells; can optionally include that the processor is further configured to control the communication circuit to obtain the RAN-related data of the subset of the plurality of cells.

In Example 25, the subject matter of any one of examples 1 to 24, may further include a memory configured to store the RAN-related data; can optionally include that the processor is further configured to obtain the RAN-related data from the memory.

In Example 26, the subject matter of any one of examples 1 to 25, can optionally include that the mobile communication network includes an open radio access network (O-RAN); can optionally include that the device is configured to implement a radio access network intelligent controller (RIC); can optionally include that the RIC includes a near real-time RIC or a non-real time RIC.

In Example 27, the subject matter of any one of examples 1 to 26, can optionally include that the RIC is configured to communicate with a plurality of distributed units (DUs) to obtain the RAN-related data and the cell-specific parameters; can optionally include that the RIC is configured to encode messages to manage radio resources of the DUs.

In Example 28, the subject matter of any one of examples 1 to 27, may further include: a transceiver configured to perform communication operations to communicate with the network access nodes providing radio access network services for the plurality of cells.

In Example 29, the subject matter of any one of examples 1 to 28, can optionally include that the processor is further configured to determine, using the trained artificial intelligence or machine learning model (AI/ML), a parameter of radio resource management of one or more first cells of the plurality of cells, can optionally include that the AI/ML has been trained using training input data may include radio access network (RAN)-related data of network access nodes of the selected subset cells of the plurality of cells; and encode information representative of the determined parameter for a transmission to network access nodes of the one or more first cells.

In Example 30, a device may include: a memory; a processor configured to: obtain parameters representative of states of each cell of a plurality of cells within a mobile communication network; determine a cell subset may include two or more cells of the plurality of cells based on obtained parameters; and train an artificial intelligence or machine learning model (AI/ML) configured to provide an output used in radio resource management of the plurality of cells with training input data may include network (RAN)-related data obtained from network access nodes of the cell subset.

In Example 31, the subject matter of example 30, can optionally include that the processor is further configured to implement the AI/ML and the processor is further configured to further perform any one of the aspects provided herein, in particular aspects described in examples 1 to 29.

In Example 32, a device may include: a memory; a processor configured to: determine, using a trained artificial intelligence or machine learning model (AI/ML), a parameter of radio resource management of one or more first cells of a plurality of cells, wherein the AI/ML has been trained using training input data may include radio access network (RAN)-related data of network access nodes of one or more second cells of the plurality of cells; and encode information representative of the determined parameter for a transmission to network access nodes of the one or more first cells.

In Example 33, the device of example 32, can optionally include that the processor is further configured to implement the AI/ML and the processor is further configured to further perform any one of the aspects provided herein, in particular aspects described in examples 1 to 29.

In Example 34, the subject matter includes a method that may include: obtaining cell-specific parameters of a plurality of cells of a mobile communication network; selecting a subset of the plurality of cells based on obtained cell-specific parameters; and causing an artificial intelligence or machine learning model (AI/ML) to be trained with radio access network (RAN)-related data of the subset of the plurality of cells, wherein radio resources of the plurality of cells are managed based on output of the AI/ML.

In Example 35, the subject matter of example 34, may further include: selectively causing the AI/ML to be trained with first data including the RAN-related data of the subset of the plurality of cells or causing the AI/ML to be trained with second data including RAN-related data of at least one or more cells that are not within the subset of the plurality of cells.

In Example 36, the subject matter of example 35, may further include: causing the AI/ML to be trained with the first data for a first period of time and cause the AI/ML to be trained with data including the second data for a second period of time.

In Example 37, the subject matter of example 35, may further include: causing the AI/ML to be trained with the first data more frequently than to cause the AI/ML to be trained with the second data.

In Example 38, the subject matter of example 35, may further include: causing the first data to be sampled continuously from first network access nodes of the subset of the plurality of cells and causing the RAN-related data of the at least one or more cells that are not within the subset of the plurality of cells to be sampled intermittently from second network access nodes.

In Example 39, the subject matter of any one of examples 34 to 38, may further include: aggregating the RAN-related data of the subset of the plurality of cells to obtain training data to be used to train the AI/ML.

In Example 40, the subject matter of any one of examples 34 to 39, may further include: selecting the subset based on operator information representative of a preference of a mobile network operator.

In Example 41, the subject matter of example 40, can optionally include that the operator information includes information representative of at least one of usable priority cells, one or more performance thresholds associated with one or more performance metrics, a number of cells in the subset, one or more cost metrics, or a preference for optimization.

In Example 42, the subject matter of any one of examples 34 to 41, can optionally include that cell-specific parameters of each cell includes information representative of at least one of network traffic, downlink traffic, uplink traffic, physical resource block (PRB) usage, reference signal strength indicator (RSSI), reference signal receive power (RSRP), data throughput, mobility, user density, geolocation, topography, traffic patterns, user equipment (UE) distribution, a number of UEs in an RRC connected state, a number of active users, user channel quality summary, or UE density.

In Example 43, the subject matter of any one of examples 34 to 42, may further include: selecting the subset of the plurality of cells based on AI/ML information representative of features of the AI/ML.

In Example 44, the subject matter of example 43, can optionally include that the AI/ML information includes information representative of at least one of exemplary cells of the plurality of cells, a performance requirement of the AI/ML model, a computation requirement of the AI/ML model, a data aggregation requirement to train the AI/ML model, a weighting parameter associated with performance and cost of operation, a mapping associated with the performance of the AI/ML and the cost of operation of the AI/ML, one or more requirements associated with input data of the AI/ML.

In Example 45, the subject matter of any one of examples 34 to 44, may further include: determining exemplary cells of the plurality of cells based on a cell selection criterion.

In Example 46, the subject matter of any one of examples 34 to 44, may further include: determining exemplary cells of the plurality of cells iteratively by adding a cell of the plurality of cells into the exemplary cells of the plurality of cells and performance of the AI/ML output of the iterations.

In Example 47, the subject matter of any one of examples 44 to 46, may further include: calculating similarity scores for multiple subsets of the cells, each calculated similarity score is representative of a similarity between one or more cell-specific parameters of cells of a respective subset and one or more cell-specific parameters of the exemplary cells.

In Example 48, the subject matter of example 47, can optionally include that the similarity scores are calculated based on a similarity mapping operation.

In Example 49, the subject matter of example 48, can optionally include that the subset of the plurality of cells is selected from the plurality of subsets of the cells, which the subset maximizes a measure with a cardinality constraint for number of cells within each subset of the multiple subsets of the cells.

In Example 50, the subject matter of example 49, can optionally include that the subset of the plurality of cells is selected by using a greedy approach that maximizes the measure.

In Example 51, the subject matter of any one of examples 47 to 50, can optionally include that the measure being I, the processor is configured to select A being the subset of the plurality of cells according to Q being the exemplary cells with a cardinality constraint |A|<b based on the similarity mapping operation Si,j denoting the mapping between i-th cell-specific parameters of the A and j-th cell-specific parameters of the Q; and can optionally include that the greedy approach is used to identify the A that maximizes the I.

In Example 52, the subject matter of any one of examples 44 to 46, may further include: selecting the subset of the plurality of cells using a reinforcement learning model; can optionally include that a reward of the reinforcement learning (RL) model is based on a performance metric of the AI/ML and a cost metric of the AI/ML.

In Example 53, the subject matter of example 52, may further include: determining a state based on the cell-specific parameters of at least the exemplary cells; determining an action by adding one or more further cells from the plurality of cells to a set may include the exemplary cells.

In Example 54, the subject matter of example 53, can optionally include that the reward of the RL model includes a mapping operation including the performance metric of the AI/ML and the cost metric of the AI/ML that are weighed.

In Example 55, the subject matter of any one of examples 34 to 54, implementing the AI/ML.

In Example 56, the subject matter of any one of examples 34 to 54, can optionally include that the AI/ML is implemented by a controller; can optionally include that the method further includes providing, to the controller, information representative of the subset of the plurality of cells; can optionally include that the controller is configured to train the AI/ML using the RAN-related data of the subset of the plurality of cells.

In Example 57, the subject matter of any one of examples 34 to 56, may further include: performing communications, with a communication circuit, with network access nodes of the plurality of cells; controlling the communication circuit to obtain the RAN-related data of the subset of the plurality of cells.

In Example 58, the subject matter of any one of examples 34 to 57, may further include: storing, at a memory, the RAN-related data; obtaining the RAN-related data from the memory.

In Example 59, the subject matter of any one of examples 34 to 58, can optionally include that the mobile communication network includes an open radio access network (O-RAN); can optionally include that the method further includes implementing a radio access network intelligent controller (RIC); can optionally include that the RIC includes a near real-time RIC or a non-real time RIC.

In Example 60, the subject matter of any one of examples 34 to 59, may further include: communicating, as the RIC, with a plurality of distributed units (DUs) to obtain the RAN-related data and the cell-specific parameters; encoding, as the RIC, messages to manage radio resources of the DUs.

In Example 61, the subject matter of any one of examples 34 to 60, may further include: performing, by a transceiver, communication operations to communicate with the network access nodes providing radio access network services for the plurality of cells.

In Example 62, the subject matter of any one of examples 34 to 61, may further include: determining, using the trained artificial intelligence or machine learning model (AI/ML), a parameter of radio resource management of one or more first cells of the plurality of cells, can optionally include that the AI/ML has been trained using training input data may include radio access network (RAN)-related data of network access nodes of the selected subset cells of the plurality of cells; and encoding information representative of the determined parameter for a transmission to network access nodes of the one or more first cells.

In Example 63, a non-transitory computer-readable medium may include one or more instructions which, if executed by a processor, cause the processor to: obtain cell-specific parameters of a plurality of cells of a mobile communication network; select a subset of the plurality of cells based on obtained cell-specific parameters; and cause an artificial intelligence or machine learning model (AI/ML) to be trained with radio access network (RAN)-related data of the subset of the plurality of cells, wherein radio resources of the plurality of cells are managed based on output of the AI/ML.

In Example 64, the non-transitory computer-readable medium of example 63, can optionally include that the one or more instructions are configured to cause the processor to perform any aspects provided in this disclosure, in particular in examples 1 to 29.

In Example 65, a non-transitory computer-readable medium may include one or more instructions which, if executed by a processor, cause the processor to perform any one of the methods of examples 34 to 62.

In Example 66, a method may include determining, using a trained artificial intelligence or machine learning model (AI/ML), a parameter of radio resource management of one or more first cells of a plurality of cells, wherein the AI/ML has been trained using training input data may include radio access network (RAN)-related data of network access nodes of one or more second cells of the plurality of cells; and encoding information representative of the determined parameter for a transmission to network access nodes of the one or more first cells.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of this disclosure accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed clements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice.” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The terminology in accordance with open-RAN (O-RAN) specifications is to be considered for Radio Units (RUs), Distributed Units (DUs) and Centralized Units (CUs). Inherently, a base station is considered to be disaggregated into such units in accordance with layers of a corresponding protocol stack into these logical nodes, which all of them can be implemented by the same device or multiple devices in which each device may be deployed with one of these units.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

Unless explicitly specified, the term “performance metric” refers to a quantitative measure used to evaluate the effectiveness, efficiency, or success of a system, process, or operation in achieving its designated objectives. For an AI/ML generally, a performance metric may include a quantitative measure to evaluate the effectiveness, accuracy, and/or quality of a trained model's predictions or classifications compared to the ground truth or actual values. It is to be noted that a performance metric of an AI/ML used for RRM operation, may also include a performance metric of RAN as the performance metric of the RAN is directly affected with the performance of the AI/ML. RAN performance metrics may include coverage (e.g. signal strength, cell capacity), capacity (e.g. traffic volume, cell capacity), QoS (data rate (throughput), latency, packet loss rate, call drop rate), resource utilization (spectrum efficiency, energy efficiency), mobility performance (handover success rate, mobile robustness), etc. The RAN performance metrics may be indicated via KPMs. Depending on the measure of the “performance”, performance metrics may include also measure to evaluate costs and/or expenses (i.e. cost expenses) in this disclosure, such as computation overhead (i.e. cost of computing), power consumption (i.e. cost of power), communication (i.e. cost of communication), unless these terms are distinguished explicitly.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. A device comprising:
a memory configured to store an artificial intelligence or machine learning model (AI/ML) configured to provide an output used in radio resource management of a plurality of cells;
a processor configured to:
obtain cell-specific parameters of the plurality of cells of a mobile communication network;
select a subset of the plurality of cells based on obtained cell-specific parameters; and
cause the AI/ML to be trained with radio access network (RAN)-related data of the subset of the plurality of cells.

2. The device of claim 1,
wherein the processor is further configured to selectively cause the AI/ML to be trained with first data including the RAN-related data of the subset of the plurality of cells or cause the AI/ML to be trained with second data including RAN-related data of at least one or more cells that are not within the subset of the plurality of cells.

3. The device of claim 2,
wherein the processor is further configured to cause the AI/ML to be trained with the first data for a first period of time and cause the AI/ML to be trained with data including the second data for a second period of time.

4. The device of claim 2,
wherein the processor is further configured to cause the AI/ML to be trained with the first data more frequently than to cause the AI/ML to be trained with the second data.

5. The device of claim 2,
wherein the processor is further configured to cause the first data to be sampled continuously from first network access nodes of the subset of the plurality of cells and to cause the RAN-related data of the at least one or more cells that are not within the subset of the plurality of cells to be sampled intermittently from second network access nodes.

6. The device of claim 1,
wherein the processor is further configured to aggregate the RAN-related data of the subset of the plurality of cells to obtain training data used to train the AI/ML.

7. The device of claim 1,
wherein the processor is further configured to select the subset based on operator information representative of a preference of a mobile network operator;
wherein the operator information comprises information representative of at least one of usable priority cells, one or more performance thresholds associated with one or more performance metrics, a number of cells in the subset, one or more cost metrics, or a preference for optimization.

8. The device of claim 1,
wherein cell-specific parameters of each cell comprises information representative of at least one of network traffic, downlink traffic, uplink traffic, physical resource block (PRB) usage, reference signal strength indicator (RSSI), reference signal receive power (RSRP), data throughput, mobility, user density, geolocation, topography, traffic patterns, user equipment (UE) distribution, a number of UEs in an RRC connected state, a number of active users, user channel quality summary, or UE density.

9. The device of claim 1,
wherein the processor is further configured to select the subset of the plurality of cells based on AI/ML information representative of features of the AI/ML;
wherein the AI/ML information comprises information representative of at least one of exemplary cells of the plurality of cells, a performance requirement of the AI/ML model, a computation requirement of the AI/ML model, a data aggregation requirement to train the AI/ML model, a weighting parameter associated with performance and cost of operation, a mapping associated with the performance of the AI/ML and the cost of operation of the AI/ML, one or more requirements associated with input data of the AI/ML.

10. The device of claim 1,
wherein the processor is further configured to determine exemplary cells of the plurality of cells based on a cell selection criterion;
wherein the processor is further configured to calculate similarity scores for multiple subsets of the cells, each calculated similarity score is representative of a similarity between one or more cell-specific parameters of cells of a respective subset and one or more cell-specific parameters of the exemplary cells.

11. The device of claim 1,
wherein the processor is further configured to determine exemplary cells of the plurality of cells iteratively by adding a cell of the plurality of cells into the exemplary cells of the plurality of cells and performance of the AI/ML output of the iterations;
wherein the processor is further configured to calculate similarity scores for multiple subsets of the cells, each calculated similarity score is representative of a similarity between one or more cell-specific parameters of cells of a respective subset and one or more cell-specific parameters of the exemplary cells.

12. The device of claim 1,
wherein the subset of the plurality of cells is selected from the plurality of subsets of the cells using a greedy approach that maximizes a measure with a cardinality constraint for number of cells within each subset of the multiple subsets of the cells;
wherein the measure being I, the processor is configured to select A being the subset of the plurality of cells according to Q being the exemplary cells with a cardinality constraint |A|<b based on the similarity mapping operation S_{i,j} denoting the mapping between i-th cell-specific parameters of the A and j-th cell-specific parameters of the Q; and
wherein the greedy approach is used to identify the A that maximizes the I.

13. The device of claim 1,
wherein the processor is further configured to select the subset of the plurality of cells based on exemplary cells using a reinforcement learning model;
wherein a reward of the reinforcement learning (RL) model is based on a performance metric of the AI/ML and a cost metric of the AI/ML.

14. The device of claim 13,
wherein the processor is further configured to determine a state based on the cell-specific parameters of at least the exemplary cells;
wherein the processor is further configured to determine an action by adding one or more further cells from the plurality of cells to a set comprising the exemplary cells.

15. The device of claim 1,
wherein the processor is further configured to implement the AI/ML.

16. The device of claim 1,
wherein the mobile communication network comprises an open radio access network (O-RAN);
wherein the device is configured to implement a radio access network intelligent controller (RIC);
wherein the RIC comprises a near real-time RIC or a non-real time RIC.

17. A device comprising:
a memory;
a processor configured to:
determine, using a trained artificial intelligence or machine learning model (AI/ML), a parameter of radio resource management of one or more first cells of a plurality of cells, wherein the AI/ML has been trained using training input data comprising radio access network (RAN)-related data of network access nodes of one or more second cells of the plurality of cells; and
encode information representative of the determined parameter for a transmission to network access nodes of the one or more first cells.

18. The device of claim 17, further comprising:
a transceiver configured to communicate the encoded information to the network access nodes of the one or more first cells.

19. A non-transitory computer-readable medium comprising one or more instructions which, if executed by a processor, cause the processor to:
obtain cell-specific parameters of a plurality of cells of a mobile communication network;
select a subset of the plurality of cells based on obtained cell-specific parameters; and
cause an artificial intelligence or machine learning model (AI/ML) to be trained with radio access network (RAN)-related data of the subset of the plurality of cells, wherein radio resources of the plurality of cells are managed based on output of the AI/ML.

20. The non-transitory computer-readable medium of claim 19,
wherein cell-specific parameters of each cell comprises information representative of at least one of network traffic, downlink traffic, uplink traffic, physical resource block (PRB) usage, reference signal strength indicator (RSSI), reference signal receive power (RSRP), data throughput, mobility, user density, geolocation, topography, traffic patterns, user equipment (UE) distribution, a number of UEs in an RRC connected state, a number of active users, user channel quality summary, or UE density.
